(19) United States
(12) Patent Application Publication
(10) Pub. No.: US 2026/0031536 A1
(43) Pub. Date: Jan. 29, 2026

(54) ANTENNA DEVICE

(71) Applicant: KMW INC., Hwaseong-si (KR)

(72) Inventors: Duk Yong KIM, Yongin-si (KR); Seong Man KANG, Hwaseong-si (KR); Hyoung Seok YANG, Hwaseong-si (KR); Oh Seog CHOI, Hwaseong-si (KR); Gyo Jin JO, Hwaseong-si (KR); Nam Jik KIM, Hwaseong-si (KR); Jang Soon PARK, Hwaseong-si (KR); Seung Han SON, Yongin-si (KR); Yong Seung LEE, Hwaseong-si (KR)

(73) Assignee: KMW INC., Hwaseong-si (KR)

(21) Appl. No.: 19/342,684

(22) Filed: Sep. 29, 2025

Related U.S. Application Data
(63) Continuation of application No. PCT/KR2024/003941, filed on Mar. 28, 2024.

(30) Foreign Application Priority Data
Mar. 30, 2023 (KR) 10-2023-0042021
Mar. 27, 2024 (KR) 10-2024-0041635

(51) Int. Cl. H01Q 5/20; H01Q 1/24; H01Q 25/00

(52) U.S. Cl. CPC H01Q 5/20; H01Q 1/246; H01Q 25/001

(57) ABSTRACT

The present disclosure relates to an antenna apparatus, and more particularly, to an antenna apparatus including a plurality of low-band elements that radiate an operating frequency in a first frequency band, and a plurality of mid-band elements that radiate an operating frequency higher than the operating frequency in the first frequency band. Among the plurality of mid-band elements, mid-band elements that interfere in a radiation direction in relation to the low-band elements are disposed to penetrate centers of the low-band elements, thereby providing an advantage of securing favorable antenna gain.

### TECHNICAL FIELD

The present disclosure relates to an antenna apparatus, and more particularly, to an antenna apparatus capable of employing an optimal arrangement structure of radiating elements having different frequency bands to improve gain of the antenna, and capable of reducing weight of components to facilitate manufacturing of a lightweight product.

### BACKGROUND ART

Recently, as an antenna apparatus for antenna devices of mobile communication base stations and Wi-Fi communication equipment, a multi-band antenna apparatus capable of communicating in a plurality of frequency bands to ensure communication capacity has been practically disposed.

Generally, in a wireless communication network such as a mobile communication network or a wireless local loop (WLL), a base station is installed between an exchange and a subscriber terminal, and wireless signals are exchanged between the base station and the subscriber terminal.

An antenna apparatus installed in the base station is designed to have a predetermined vertical/horizontal beam pattern and beam directivity characteristic in consideration of a spatial distribution of subscribers.

Recently, existing mobile communication operators have been acquiring business rights in frequency bands other than frequency bands already allocated to the mobile communication operators and diversifying services, and in response to demands due to such changes in radio wave environments, beam characteristics such as a beam width and a beam tilt of an antenna (radiating element) are required to be varied.

In other words, in the case where a beam width of a communication antenna or a broadcasting antenna is fixed, there is a problem in that when a change in the beam width occurs, the antenna needs to be replaced with another antenna that satisfies the change. Therefore, recently, a structure configured to cope with beam characteristic variations such as beam width or beam tilt through shifting a phase value by changing a physical length of a transmission line provided for radiating elements has been employed.

However, in order to change the physical length of the transmission line, a phase shifter needs to be provided. A relatively large space occupied by the phase shifter hinders slimming of a product, and complexity of the transmission line leads to a problem of cost increase in a manufacturing process.

Multi-band antenna apparatuses include a plurality of dipole-type antenna patch elements configured to radiate beam patterns of operating frequencies of multiple frequency bands.

Such a multi-band antenna apparatus constitutes an antenna array in which cross-dipole antenna patch elements (hereinafter referred to as ‘radiating elements,’ LB antenna: low-band antenna, MB antenna: mid-band antenna) for a plurality of frequency bands are alternately arranged on a reflecting panel.

Here, with regard to an arrangement of the radiating elements of the LB antenna and the MB antenna (hereinafter, antenna patch elements of the LB antenna are referred to simply as ‘low-band elements,’ and antenna patch elements of the MB antenna are referred to simply as ‘mid-band elements’) on the reflecting panel, it is preferable that the radiating elements are disposed to be spaced apart from each other as much as possible so that beam patterns radiated and formed from the respective radiating elements are directly radiated and formed without mutual interference.

However, because the arrangement in which the radiating elements are spaced apart from each other inevitably enlarges an overall size of a product, recently, product size has been reduced by arranging the mid-band elements, which have a relatively small radiating surface area, inside the low-band elements having a larger surface area, in an overlapping manner.

As such, recently, in arranging a plurality of radiating elements applied to multi-band antenna apparatuses, research on an arrangement or overlapping arrangement capable of providing the most efficient antenna gain has been actively conducted, and efforts have been made to reduce a volume occupying thickness in a forward and backward direction as much as possible, and to reduce weight of components to achieve slimming and weight reduction of an entire product.

### DISCLOSURE

### Technical Problem

The present disclosure has been made in an effort to solve the above-mentioned technical problem, and an object of the present disclosure is to provide an antenna apparatus capable of optimally arranging a plurality of radiating elements of a multi-band antenna apparatus to achieve excellent antenna gain.

In addition, another object of the present disclosure is to provide an antenna apparatus capable of minimizing weight of components to achieve weight reduction of an entire product.

Furthermore, still another object of the present disclosure is to provide an antenna apparatus capable of minimizing a thickness occupied in a forward and backward direction by predetermined components to enable slim design of an entire product.

Technical objects of the present disclosure are not limited to the aforementioned objects, and the other objects not described above may be evidently understood from the following description by those skilled in the art.

### Technical Solution

An antenna apparatus according to an embodiment of the present disclosure may include a plurality of low-band elements configured to radiate an operating frequency in a first frequency band, and a plurality of mid-band elements configured to radiate an operating frequency higher than the operating frequency in the first frequency band. A dipole pattern configured to radiate at least one polarized beam of dual polarization may be plated on an outer surface of each of the plurality of low-band elements.

Here, the plurality of low-band elements and the plurality of mid-band elements may each be secured to a front surface of a reflecting panel, and may be independently fed by a first transmission line disposed on the front surface of the reflecting panel and a second transmission line disposed on a rear surface of the reflecting panel.

Furthermore, the first transmission line and the second transmission line may be respectively provided in an air strip line form spaced apart from the front surface or the rear surface of the reflecting panel by a predetermined distance by a plurality of spacing supports.

Furthermore, among the plurality of mid-band elements, mid-band elements that interfere in a radiation direction in relation to the low-band elements may be disposed to penetrate centers of the low-band elements.

In addition, each of the plurality of low-band elements may include a low-band element body formed of a non-conductive material and having, at a center thereof, an element installation hole formed to pass therethrough in a forward and rearward direction so that the corresponding mid-band element is installed to penetrate through the element installation hole. The dipole pattern may be plated to close a peripheral edge portion of the element installation hole, and may be plated such that a front end thereof extends from the peripheral edge portion of the element installation hole forward along edge surfaces formed by cutting, in a flat chamfered form, edges of the low-band element body having a square front perimeter that serves as the front end of the low-band element body.

In addition, the dipole pattern may include a ground portion plated on the peripheral edge portion of the element installation hole and configured to ground the mid-band element.

Moreover, the dipole pattern may include a dipole radiation end plated in a T-shape branching along adjacent sides of a square vertical cross-section at the front end of the low-band element body.

Furthermore, the front end of the low-band element body on which the dipole radiation end is plated may include a bent surface bent with respect to an inclined side surface extending obliquely with respect to the front surface of the reflecting panel on which the low-band elements and the mid-band elements are installed.

Furthermore, the bent surface may be bent perpendicular to the front surface of the reflecting panel.

In addition, the bent surface may be bent to reduce the vertical cross-sectional area as compared with an area of the square vertical cross-section of the front end of the low-band element without the bent surface, so that beam interference of the mid-band element disposed between the adjacent low-band elements is avoided.

In addition, a distal end of the dipole radiation end may be spaced apart from a distal end of an adjacent dipole radiation end, and may be plated to be bent and extended toward the element installation hole by a predetermined ratio with respect to an area of the vertical cross-section reduced by the bent surface, and to be arranged parallel to the distal end of the adjacent dipole radiation end.

In addition, an inner feeding pattern configured to feed the dipole pattern may be plated on an inner surface of the low-band element. One end of the inner feeding pattern may be connected to an output end of the first transmission line. A remaining end of the inner feeding pattern may be electrically connected to the dipole pattern through a feeding via hole passing through inner and outer sides of the low-band element.

Moreover, the dipole pattern and the inner feeding pattern may be pattern-plated on the low-band element body through a plastic electro-plating (PEP) process.

Furthermore, each of the plurality of mid-band elements may include a base panel mediating coupling to the reflecting panel, a balun portion having a rear end secured to the base panel and having an outer feeding pattern printed thereon, a radiating panel secured to a front end of the balun portion, and formed with a dipole pattern connected to the outer feeding pattern and configured to radiate a predetermined pattern beam, and a radiating director stacked and disposed on a front side of the radiating panel.

Furthermore, the radiating panel may be formed such that a portion of an end thereof forming the dipole pattern is bent toward the reflecting panel.

Furthermore, the antenna apparatus may further include an extended director panel disposed to be spaced apart from the radiating director forward.

In addition, the antenna apparatus may further include an antenna housing including: a rear panel functioning as a structural frame; side panels coupled to left and right ends of the rear panel, and forming a thickness in a forward and backward direction; a radome panel coupled to front ends of the side panels and provided to form an internal space in which an antenna board assembly provided with the plurality of low-band elements, the plurality of mid-band elements, and the reflecting panel is installed; an upper cap panel configured to cover an open portion at an upper side; and a lower cap panel configured to cover an open portion at a lower side. A reinforcing frame configured to reinforce rigidity may be coupled to an inner side of the rear panel.

In addition, the antenna housing may be made of either an aluminum material or a plastic resin material.

In addition, the reinforcing frame may include a plurality of left-right reinforcing bars coupled horizontally in a left and right direction to a front surface of the rear panel, and a center reinforcing bar coupled vertically in an up and down direction to the plurality of left-right reinforcing bars and connecting intermediate portions of the plurality of left-right reinforcing bars.

Furthermore, the radome panel may be coupled to the front ends of the side panels by a plurality of coupling clips.

In addition, a left sealer and a right sealer may be respectively interposed between a left end of the radome panel and the corresponding side panel and between a right end of the radome panel and the corresponding side panel.

### Advantageous Effects

According to an antenna apparatus of an embodiment of the present disclosure, antenna gain can be improved by optimally arranging a plurality of radiating elements implementing functions of a multi-band antenna. In addition, overall weight of a product may be reduced by reducing weight of a relatively heavy reflecting panel, an effect of achieving weight reduction of the product may be obtained.

In addition, because the present disclosure enables phase value shifting according to variation of a dielectric constant of a dielectric without a need to change a physical length of a transmission line provided in an air strip line form, not only can slim design of a product be achieved, but an effect of reducing manufacturing cost in a product process can also be obtained.

### DESCRIPTION OF DRAWINGS

FIG. 1 is a perspective view illustrating an external shape of an antenna apparatus in which a phase shifter is installed according to an embodiment of the present disclosure.

FIGS. 2a and 2b are respectively front and rear exploded perspective views illustrating the configuration of FIG. 1 from which an antenna housing is separated.

FIG. 3 is a perspective view illustrating an external shape of the configuration in (a) of FIG. 1 from which a radome panel is removed.

FIG. 4 is a perspective view illustrating an external shape of the configuration in (b) of FIG. 1 from which a rear panel is removed.

FIG. 5 is a perspective view illustrating an antenna board assembly on which the phase shifter is installed according to an embodiment of the present disclosure.

FIG. 6 is an exploded perspective view illustrating the configuration of FIG. 5 from which low-band elements and mid-band elements are separated.

FIG. 7 is an exploded perspective view illustrating the configuration of FIG. 5 from which only the low-band elements are separated.

FIG. 8 is an exploded perspective view illustrating overlapping installation of the low-band elements and the mid-band elements in the configuration of FIG. 5.

FIGS. 9a and 9b are exploded perspective views illustrating a front surface and a rear surface of reflecting panel, on which the low-band elements and the mid-band elements are installed, in the configuration of FIG. 5.

FIGS. 10a and 10b are respectively front and rear perspective views illustrating a low-band phase shifter and a mid-band phase shifter installed on the reflecting panel.

FIGS. 11a and 11b are respectively exploded perspective views of FIGS. 10a and 10b, and enlarged views of portions thereof.

FIGS. 12a and 12b are a front view and a rear view of FIGS. 10a and 10b, respectively.

FIG. 13 is a cutaway perspective view illustrating a dielectric panel for phase adjustment among components of the phase shifter of the antenna apparatus according to an embodiment of the present disclosure, and an enlarged view of a portion thereof.

FIG. 14 is a partially enlarged perspective view for explaining an operation of the phase shifter for antenna apparatuses according to an embodiment of the present disclosure.

FIG. 15 is a sectional view taken along line B-B of FIG. 14.

FIG. 16 is a schematic view for explaining a function of the dielectric panel for phase adjustment among the components of the phase shifter of the antenna apparatus according to an embodiment of the present disclosure.

FIGS. 17a and 17b are exploded perspective views illustrating coupling of the low-band element to the reflecting panel and the transmission line.

FIGS. 18a and 18b are exploded perspective views illustrating coupling of the mid-band element to the reflecting panel and the transmission line.

FIG. 19 shows front and rear perspective views illustrating coupling of radiating elements among the components of the antenna apparatus according to an embodiment of the present disclosure.

FIGS. 20a and 20b are respectively front and rear exploded perspective views of FIG. 19.

FIG. 21 is a sectional view illustrating arrangement of the radiating elements with respect to the reflecting panel according to various examples among the components of the antenna apparatus according to an embodiment of the present disclosure.

FIG. 22 is a perspective view illustrating the low-band element among the components of the antenna apparatus according to an embodiment of the present disclosure.

FIG. 23 illustrates a front view and a rear view of FIG. 22.

FIG. 24 is a side view of FIG. 22.

FIG. 25 is a perspective view illustrating the mid-band element among the components of the antenna apparatus according to an embodiment of the present disclosure.

FIG. 26 is an exploded perspective view of FIG. 25.

FIG. 27 illustrates a front view and a rear view of FIG. 25.

FIG. 28 is a side view of FIG. 25.

FIG. 29 illustrates another example of the mid-band element among the components of the antenna apparatus according to an embodiment of the present disclosure.

FIG. 30 is an exploded perspective view of FIG. 29.

FIG. 31 illustrates a partial front view (a) of a first transmission line for explaining phase difference implementation according to position and depth adjustment of an impedance matching step of the phase dielectric among the components of the phase shifter of the antenna apparatus according to an embodiment of the present disclosure, and a graph (b) illustrating an ideal phase difference.

### DESCRIPTION OF REFERENCE NUMERALS

1: antenna apparatus
5: antenna housing
10: rear panel
20: side panel
30: radome panel
40: cap panel
50: reinforcing frame
100: antenna board assembly
110: reflecting panel
120, 130: radiating element(s)
120: low-band element
121: element installation hole
122: low-band element body
126: dipole pattern
130: mid-band element
131: radiating panel
132a, 132b: dipole pattern
133: balun portion
134: radiating director
136: extended director panel
138: base panel
139a, 139b: lead terminal
200: first transmission line
210L, 210R: input line
220U: upper transmission line
220D: lower transmission line
300: second transmission line
400A, 400B: phase shifter
410: driving motor
411: pinion gear teeth
420: rack gear
421: rack gear teeth
430: vertical moving bar
440: moving clamp
450: dielectric panel for phase adjustment
455: impedance matching step
460: dielectric panel for impedance matching

### BEST MODE

Hereinafter, a phase shifter for antenna apparatuses according to an embodiment of the present disclosure will be described in detail with reference to the attached drawings.

It should be noted that in assigning reference numerals of each drawing, like reference numerals refer to like elements as much as possible even though like elements are shown in different drawings. Furthermore, in the following description of embodiments of the present disclosure, detailed descriptions of related known configurations or functions will be omitted when it is determined that the detailed descriptions would obscure the understanding of the embodiments of the present disclosure.

The terms first, second, A, B, (a), and (b) may be used to describe elements of the embodiments of the present disclosure. These terms are used only for the purpose of discriminating one constituent element from another constituent element, and the nature, the sequences, or the orders of the constituent elements are not limited by the terms. Furthermore, unless otherwise defined, all terms used herein, including technical or scientific terms, have the same meaning as commonly understood by those skilled in the art to which the present disclosure pertains. The terms such as those defined in commonly used dictionaries should be interpreted as having meanings consistent with meanings in the context of related technologies and should not be interpreted as ideal or excessively formal meanings unless explicitly defined in the present application.

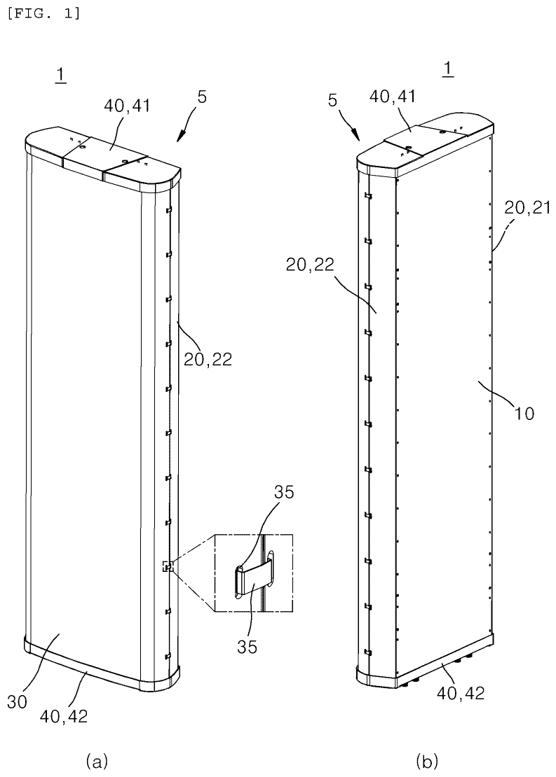

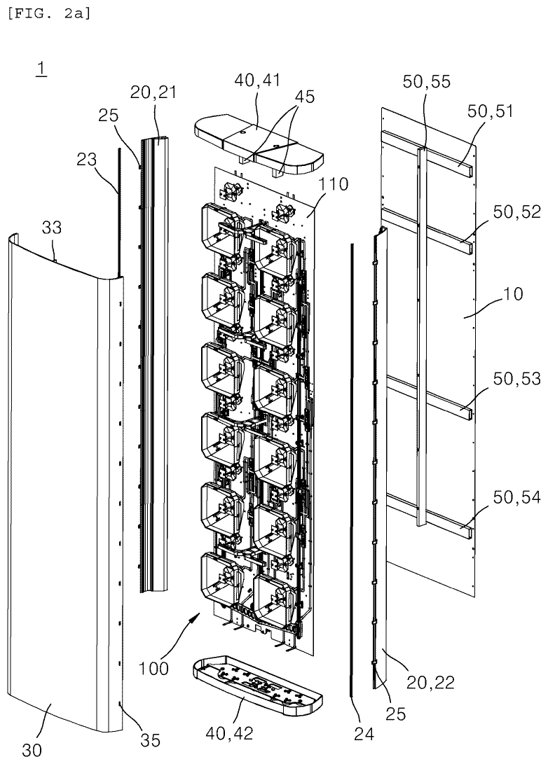

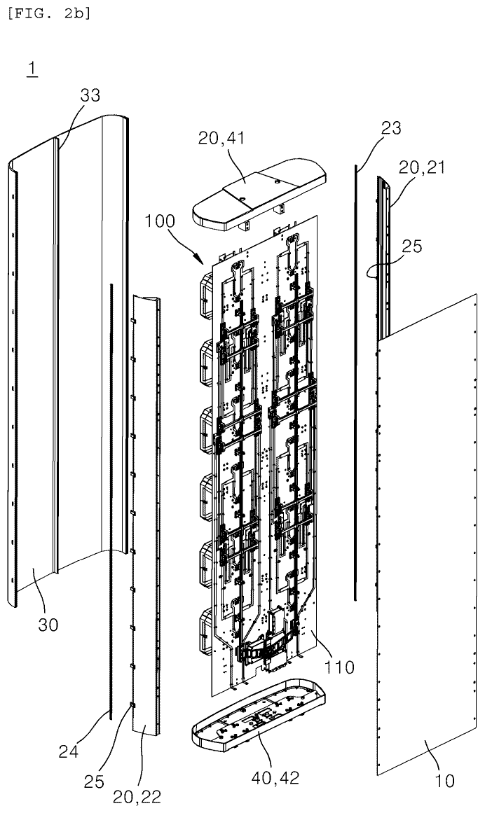

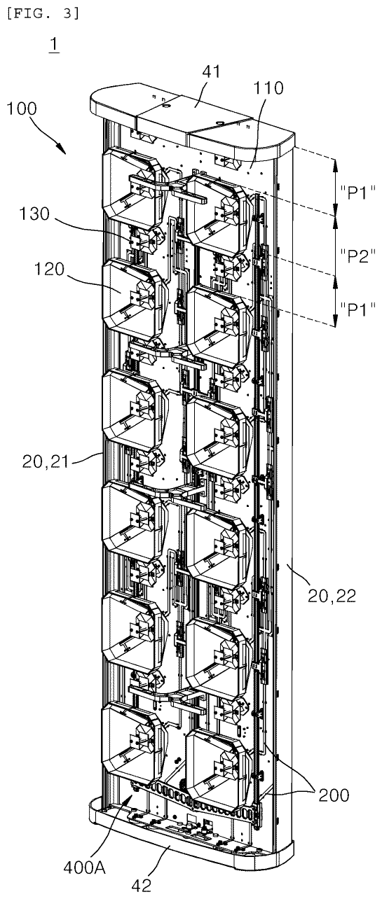

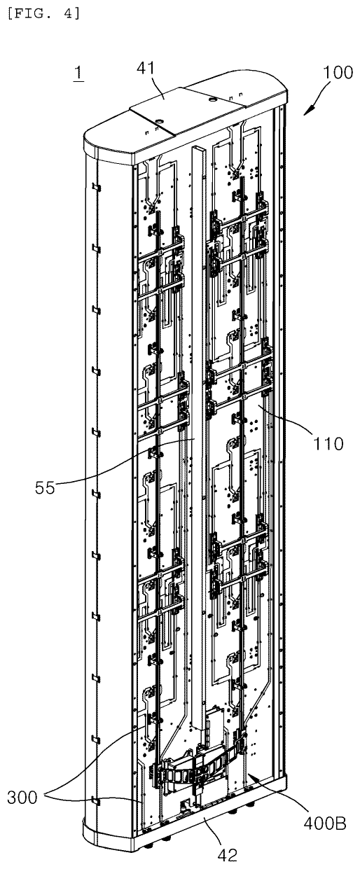

FIG. 1 is a perspective view illustrating an external shape of an antenna apparatus in which a phase shifter is installed according to an embodiment of the present disclosure. FIGS. 2a and 2b are respectively front and rear exploded perspective views illustrating the configuration of FIG. 1 from which an antenna housing is separated. FIG. 3 is a perspective view illustrating an external shape of the configuration in (a) of FIG. 1 from which a radome panel is removed. FIG. 4 is a perspective view illustrating an external shape of the configuration in (b) of FIG. 1 from which a rear panel is removed.

An antenna apparatus 1 according to an embodiment of the present disclosure includes an antenna housing 5 having an internal space (reference numeral not shown), and an antenna board assembly 100 disposed vertically in an up and down direction in the internal space of the antenna housing 5.

As referred to in FIGS. 1, 2a, and 2b, the antenna housing 5 includes a rear panel 10 that functions as a structural frame, side panels 20 provided with a left body panel 21 and a right body panel 22, which are coupled to left and right ends of the rear panel 10 and form a thickness in a forward and backward direction, a radome panel 30 coupled to front ends of the side panels 20 to shield an internal space, and cap panels 40 provided with an upper cap panel 41 configured to cover an open portion at an upper side, and a lower cap panel 42 configured to cover an open portion at a lower side.

The rear panel 10, which forms an external shape of a rear surface of the antenna housing 5, may be provided in a thin panel form. Here, the rear panel 10 may be formed of an aluminum material, but is not necessarily limited thereto, and does not exclude a non-metallic material such as a plastic resin material.

On a front surface (i.e., an internal space side) of the rear panel 10, a reinforcing frame 50 may be installed to reinforce rigidity of the rear panel 10 provided in a thin panel form. The reinforcing frame 50 may include a plurality of left-right reinforcing bars 51 to 54 coupled horizontally in a left and right direction on the front surface of the rear panel 10 and spaced apart from each other in the up and down direction by a predetermined distance, and a center reinforcing bar 55 that is coupled vertically in the up and down direction to the plurality of left-right reinforcing bars 51 to 54 and connects intermediate portions of the plurality of left-right reinforcing bars 51 to 54.

Respective rear ends of the left body panel 21 and the right body panel 22 may be coupled to the left end and the right end of the rear panel 10 to form side surfaces of the antenna housing 5. Respective front ends of the left body panel 21 and the right body panel 22 may be coupled to the radome panel 30 by using a plurality of coupling clips 25 provided for coupling with the radome panel 30. Left and right ends of the radome panel 30 may be bent rearward with a predetermined curvature, and clip grooves 35 may be formed at positions corresponding to the plurality of coupling clips 25 to enable latching engagement of the coupling clips 25.

A left sealer 23 and a right sealer 24 may be respectively interposed between the left body panel 21 and the left end of the radome panel 30, and between the right body panel 22 and the right end of the radome panel 30, thereby preventing external water (rainwater, etc.) from entering the internal space.

However, although not illustrated in the drawings, it is apparent that components identical to the above-described left sealer and right sealer may also be interposed between the left body panel 21 and the left end of the rear panel 10, and between the right body panel 22 and the right end of the rear panel 10.

The left sealer 23 and the right sealer 24 may be formed of a rubber material, and may be deformed in shape by coupling force provided upon coupling of the radome panel 30 and by coupling force provided upon coupling of the side panels 20 to the rear panel 10, thereby sealing respective gaps between the components.

The upper cap panel 41 of the cap panels 40 may be more firmly coupled to upper ends of the rear panel 10, the left body panel 21, the right body panel 22, and the radome panel 30 through a pair of coupling mediation blocks 45 that mediate coupling to an upper end of a reflecting panel 110 of components of the antenna board assembly 100 to be described later.

In addition, the lower cap panel 42 of the cap panels 40 may be formed with a plurality of through-holes or connection terminals (not shown) for connection of an external feeding cable (not shown). The lower cap panel 42 may also be collectively coupled to lower ends of the rear panel 10, the left body panel 21, the right body panel 22, and the radome panel 30.

The radome panel 30 may protect an internal configuration of the antenna board assembly 100 provided in the internal space from outside, and may be formed of a radio wave transmissive material that allows radiation from radiating elements 120 and 130 provided with low-band elements 120 and mid-band elements 130, which are described later, to be smoothly performed.

As referred to in FIGS. 3 and 4, the antenna board assembly 100 may be disposed in the internal space of the antenna housing 5.

More specifically, as referred to in FIGS. 3 and 4, in the internal space of the antenna housing 5, the plurality of radiating elements 120 and 130 may be arranged at a front side of the reflecting panel 110 so as to form a plurality of rows and columns in the up and down direction and in the left and right direction. A transmission line 300 in an air strip line form for feeding radiating elements related to one frequency band (for example, the mid-band elements 130 in the present embodiment) among the plurality of radiating elements 120 and 130 may be disposed at a rear side of the reflecting panel 110.

For reference, in an embodiment of the present disclosure, a structure is employed in which the plurality of radiating elements 120 and 130 are arranged to form six columns in the up and down direction and two rows in the left and right direction. That is, a structure is employed in which, in the up and down column direction, mid-band elements 130 are disposed between the respective low-band elements 120 to be described later, and a single mid-band element 130 is disposed at a central portion of each of the low-band elements 120.

Either the rear panel 10 or the side panel 20 may be provided with a lower clamp (not shown) and an upper clamp (not shown) that mediate coupling to a support pole P placed upright on a bottom surface of an installation space, so that an upper end of the antenna housing 5 may be tilted at a predetermined angle in the forward and backward direction with respect to a lower end of the antenna housing 5 to adjust a beam radiation direction.

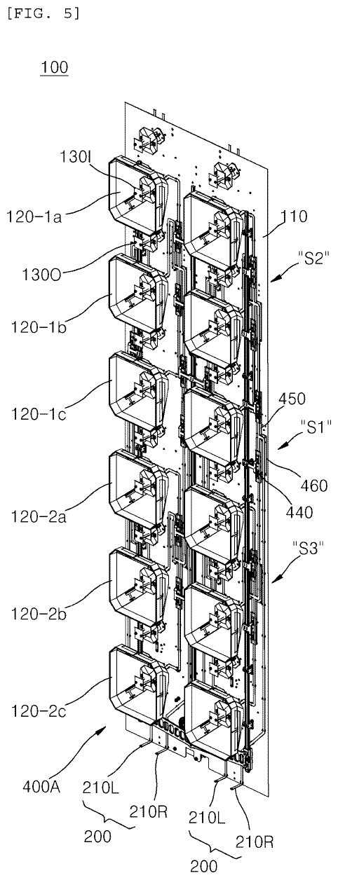

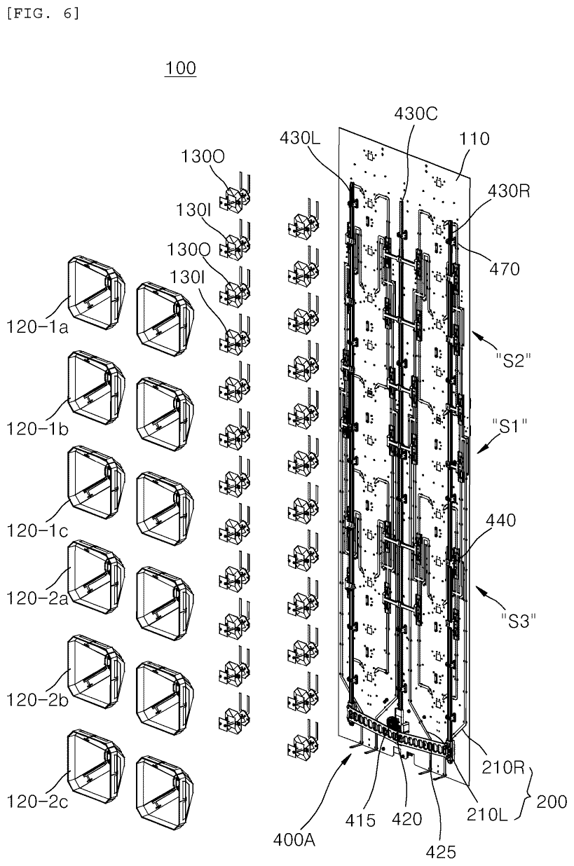

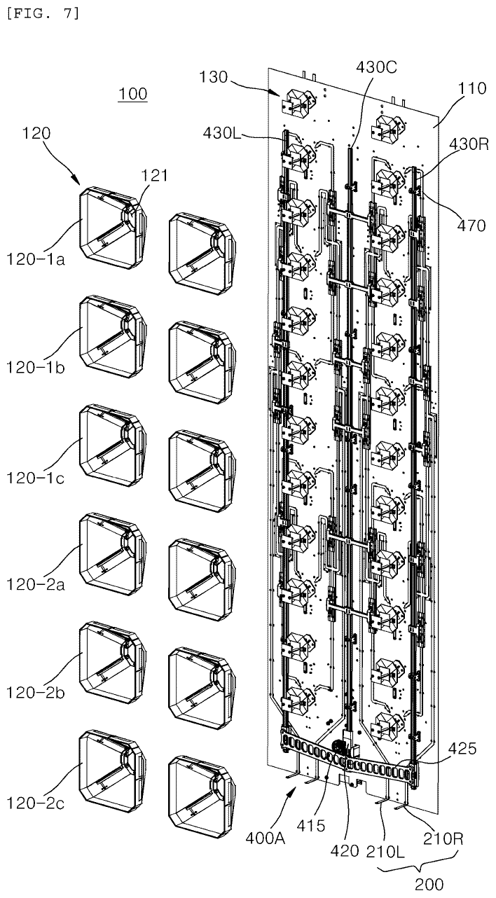

FIG. 5 is a perspective view illustrating an antenna board assembly on which the phase shifter is installed according to an embodiment of the present disclosure. FIG. 6 is an exploded perspective view illustrating the configuration of FIG. 5 from which low-band elements and mid-band elements are separated. FIG. 7 is an exploded perspective view illustrating the configuration of FIG. 5 from which only the low-band elements are separated.

In the antenna apparatus 1 according to an embodiment of the present disclosure, the antenna board assembly 100 may include radiating elements 120 and 130 disposed on the front side of the reflecting panel 110, as referred to in FIGS. 5 to 7. Here, the reflecting panel 110 may be formed of a material that performs a role of reflecting a frequency beam radiated from the radiating elements 120 and 130 at the front side forward.

The radiating elements 120 and 130 are communication components that perform a role of radiating a beam in a predetermined frequency band when fed from a low-band transmission line 200 and a mid-band transmission line 300 to be described later.

Here, the predetermined frequency band may be limited to a single fixed frequency band, but in an embodiment of the present disclosure, description is limited to the case where a first frequency band, which is a relatively low frequency band, and a second frequency band, which is a relatively high frequency band, are applied.

Therefore, the radiating elements 120 and 130 may include the low-band elements 120 capable of radiating a beam in the first frequency band, and the mid-band elements 130 capable of radiating a beam in the second frequency band.

As such, in the case where the radiating elements 120 and 130 are provided to radiate beams of different frequency bands, it is preferable that the radiating elements 120 and 130 are disposed at positions where mutual interference between the radiated beams does not occur.

However, in terms of securing isolation, it is most preferable that a horizontal interval between adjacent radiating elements 120 and 130 is maintained at a distance of at least ½ of a wavelength relative to the frequency, and in order to avoid interference therebetween, spacing apart all of the radiating elements 120 and 130 for each frequency band may cause a problem that an overall size of the product is increased.

Accordingly, the antenna apparatus 1 according to an embodiment of the present disclosure may be designed such that the mid-band elements 130, which are relatively small in size, are disposed in portions overlapping in the forward and backward direction with the low-band elements 120, which are relatively large in size, so that each frequency band may smoothly radiate a pattern beam while preventing enlargement of the overall size of the product.

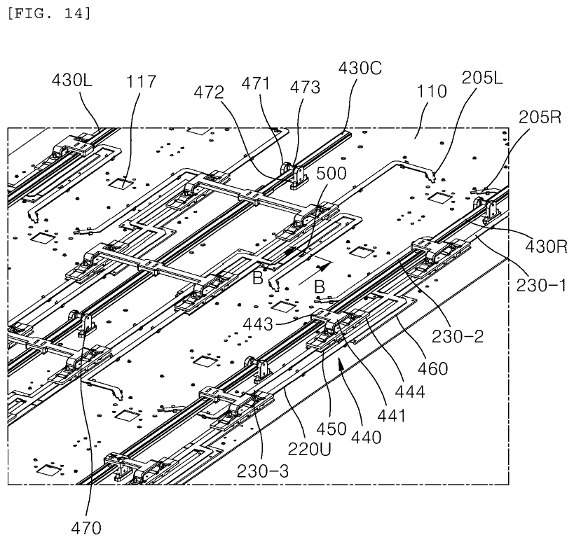

More specifically, as referred to in FIG. 3 (including FIG. 14 to be described later), the low-band elements 120 may be disposed on a front surface of the reflecting panel 110 to be spaced apart from each other by a predetermined distance in the up and down direction, and the mid-band elements 130 may be alternately disposed in regions P1 provided without beam interference with the low-band elements 120 and in regions P2 provided with beam interference with the low-band elements 120. Hereinafter, the mid-band elements 130 disposed in the regions P1 provided without beam interference are referred to as outer mid-band elements 1300, and the mid-band elements 130 disposed in the regions P2 provided with beam interference are referred to as inner mid-band elements 130I.

The inner mid-band elements 130I disposed in the regions P2 with the beam interference may be provided to be exposed forward through element installation holes 121 respectively formed at centers of the low-band elements 120.

As referred to in FIGS. 5 to 7, a total of six low-band elements 120 (120-1a to -1c and 120-2a to -2c) may be disposed to be spaced apart from each other by a predetermined distance in the vertical direction (hereinafter referred to as “V-direction”), thereby constructing at least one RF channel.

Here, the mid-band elements 130 may be disposed in a total of twelve in the V-direction, in that the inner mid-band elements 130I are provided in the element installation holes 121 of the respective low-band elements 120, and one outer mid-band element 1300 is further provided in a region P1 without beam interference that is further provided outside each of the respective low-band elements 120.

The low-band elements 120 and the mid-band elements 130 may be arranged in two in the horizontal direction (hereinafter referred to as “H-direction”).

The low-band elements 120 and the mid-band elements 130 may be fed through the transmission lines 200 and 300, which are independently disposed, so that beams corresponding to respective frequency bands may be radiated, and the respective elements 120 and 130 arranged in the V-direction may radiate beams with unique phase values to form a specific pattern beam (beamforming).

The transmission lines 200 and 300 may be intensively disposed on either a front surface or a rear surface of the reflecting panel 110. However, in the antenna apparatus 1 according to an embodiment of the present disclosure, phase shifters 400A and 400B described below are separately provided as a low-band phase shifter 400A and a mid-band phase shifter 400B so as to independently shift phases of the radiation beams of the low-band elements 120 and the mid-band elements 130 of two frequency bands. To minimize operational interference between the respective phase shifters 400A and 400B, the transmission line 200 related to the low-band elements 120 is disposed on the front surface of the reflecting panel 110, and the transmission line 300 related to the mid-band elements 130 is disposed on the rear surface of the reflecting panel 110.

Hereinafter, among the transmission lines 200 and 300, a line disposed on the front surface of the reflecting panel 110 and performing a function of feeding the low-band elements 120 will be referred to as a “low-band transmission line,” and reference numeral 200 will be assigned thereto, and a line disposed on the rear surface of the reflecting panel 110 and performing a function of feeding the mid-band elements 130 will be referred to as a “mid-band transmission line,” and reference numeral 300 will be assigned thereto.

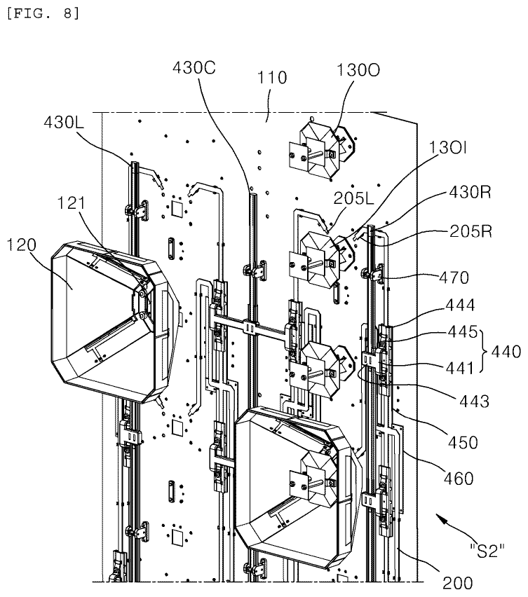

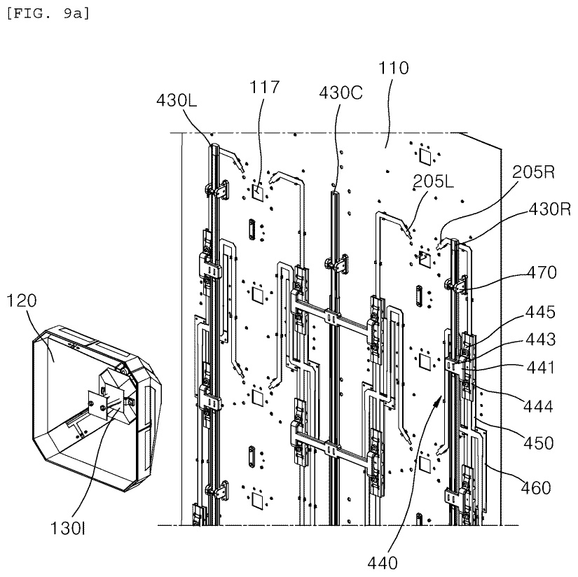

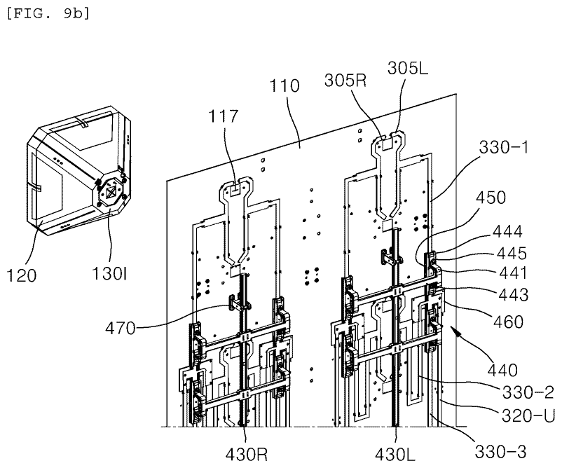

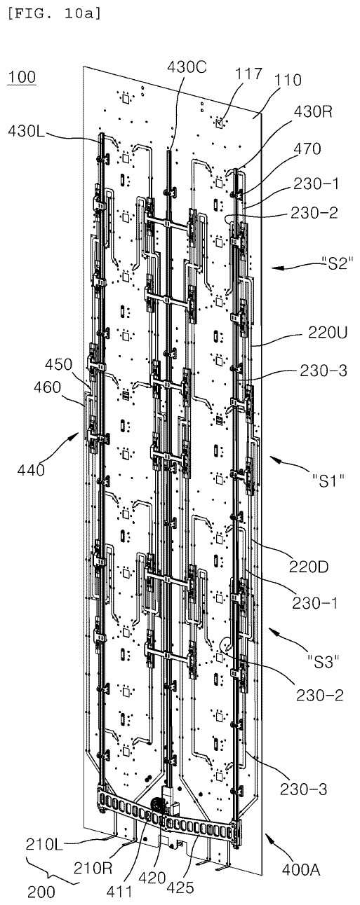

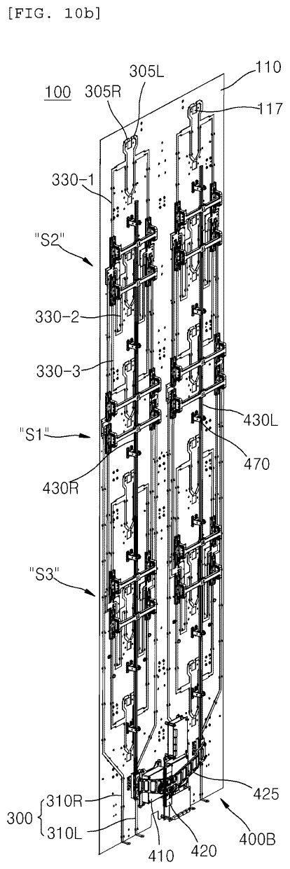

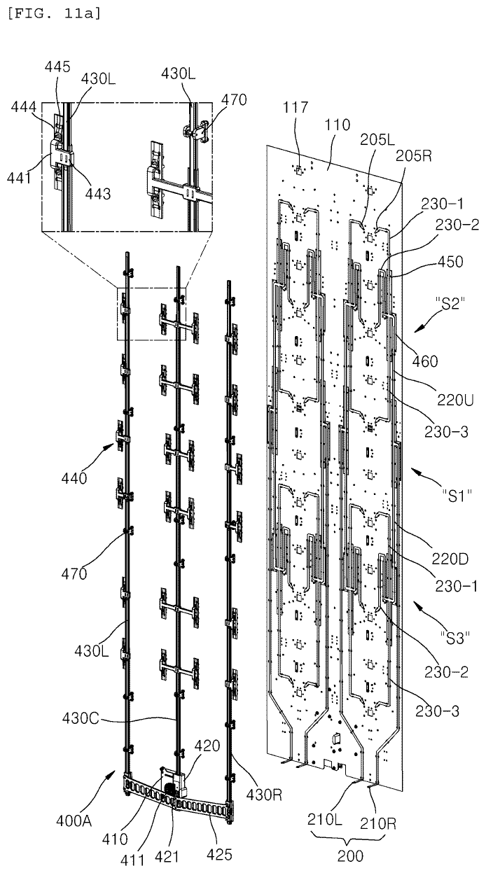

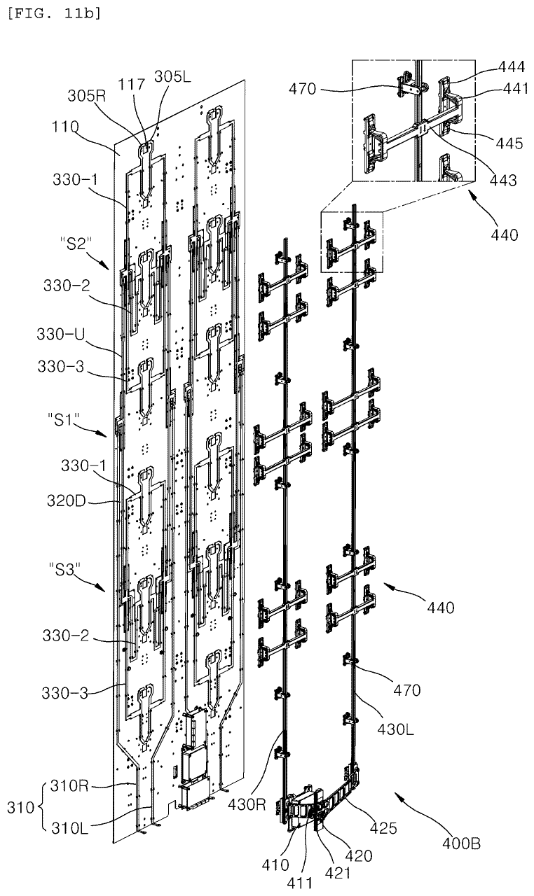

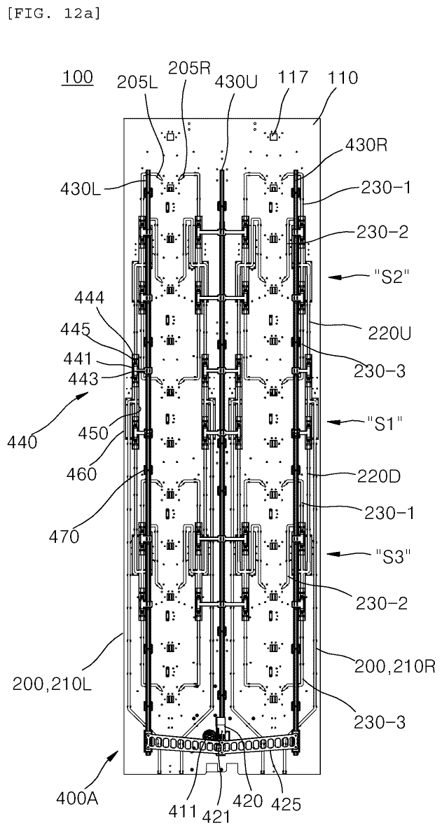

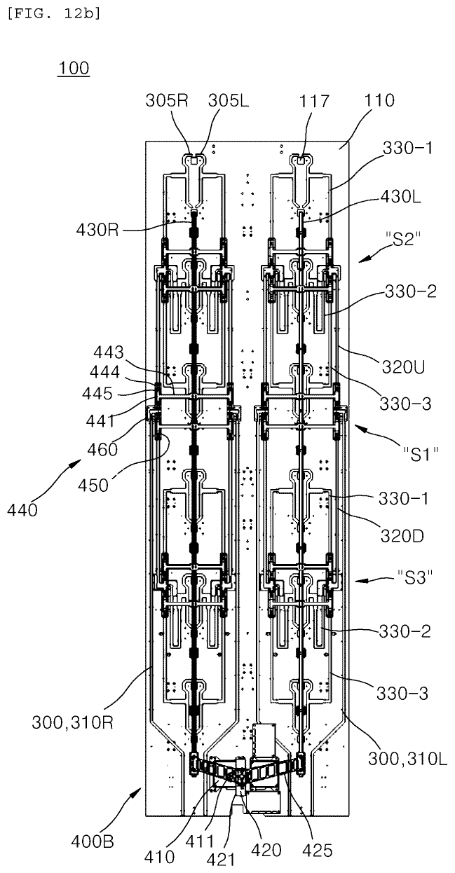

FIG. 8 is an exploded perspective view illustrating overlapping installation of the low-band elements and the mid-band elements in the configuration of FIG. 5. FIGS. 9a and 9b are exploded perspective views illustrating a front surface and a rear surface of a reflecting panel, on which the low-band elements and the mid-band elements are installed, in the configuration of FIG. 5. FIGS. 10a and 10b are respectively front and rear perspective views illustrating a low-band phase shifter and a mid-band phase shifter installed on the reflecting panel. FIGS. 11a and 11b are respectively exploded perspective views of FIGS. 10a and 10b, and enlarged views of portions thereof. FIGS. 12a and 12b are a front view and a rear view of FIGS. 10a and 10b, respectively.

The low-band elements 120 and the mid-band elements 130 may be dual-polarization elements configured to generate at least one polarized beam of dual polarization when fed at two positions through respective different transmission lines.

Here, as referred to in FIGS. 3 to 12B, the low-band transmission line 200 and the mid-band transmission line 300 may be disposed such that two input transmission lines 210L and 210R and two input transmission lines 310L and 310R are respectively disposed on the front surface and the rear surface of the reflecting panel 110 so as to feed, at two positions, each type of the low-band elements 120 and the mid-band elements 130 arranged in the V-direction.

First, with regard to the low-band transmission line 200, the left input line 210L and the right input line 210R may be linearly extended and disposed on the left portions and the right portions of the low-band elements 120, respectively, through the lower cap panel 42.

An upper end of each of the left input line 210L and the right input line 210R may be disposed in an intermediate portion of the low-band elements 120 arranged in the V-direction, and from the upper end (a first branch point S1), the corresponding line may be branched into branch lines including an upper transmission line 220U and a lower transmission line 220D, and extended.

At respective front ends (a second branch point S2 and a third branch point S3) of the upper transmission line 220U and the lower transmission line 220D, the upper transmission line 220U and the lower transmission line 220D may be respectively branched toward three upper low-band elements 120-1a to 120-1c positioned relatively above and three lower low-band elements 120-2a to 120-2c positioned relatively below, and each may extend to form branch lines, which are three branch transmission lines 230-1 to 230-3.

Hereinafter, an end of each of the three branch transmission lines 230-1 to 230-3 will be defined as a corresponding one of output ends 205L and 205R serving as feeding ends for feeding connection to one side and a remaining side of each low-band element 120.

Each of the output ends 205L and 205R may be connected to a feeding pattern formed on an outer surface or an inner surface of the low-band element 120 when the low-band element 120 is mounted, so that feeding can be achieved.

The mid-band transmission line 300 differs from the low-band transmission line 200 in that the mid-band transmission line 300 is disposed on the rear surface of the that each reflecting panel 110 and of three branch transmission lines 330-1 to 330-3 is further branched into two lines at an end thereof.

More specifically, in the mid-band transmission line 300, the left input line 310L and the right input line 310R may be linearly extended and disposed on the left portions and the right portions of the mid-band elements 130, respectively, through the lower cap panel 42.

Here as well, an upper end of each of the left input line 310L and the right input line 310R may be disposed in an intermediate portion of the mid-band elements 130 arranged in the V-direction, and from the upper end (a first branch point S1), the corresponding line may be branched into branch lines including an upper transmission line 320U and a lower transmission line 320D, and extended.

At respective front ends (a second branch point S2 and a third branch point S3) of the upper transmission line 320U and the lower transmission line 320D, the upper transmission line 320U and the lower transmission line 320D may be respectively branched toward six mid-band elements 130 positioned relatively above and six mid-band elements 130 positioned relatively below, and each may extend to form branch lines, which are three branch transmission lines 330-1 to 330-3.

At respective front ends of the three branch transmission lines 330-1 to 330-3, as a difference from the low-band transmission line 200 as described above, the lines may be further branched to form two branch lines, and ends thereof may function as the output ends 305L and 305R as described above.

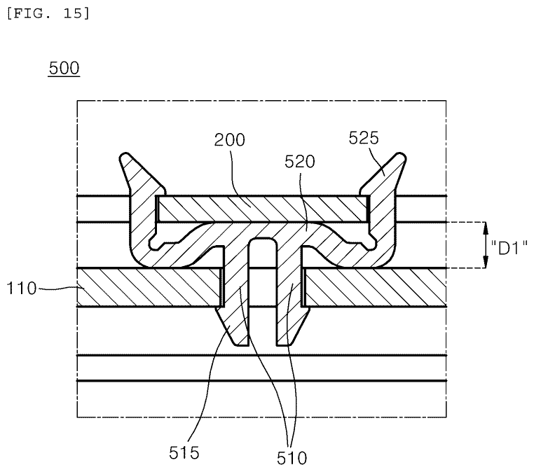

The transmission lines 200 and 300 as described above may be provided in the form of an air strip line disposed to be spaced apart by a predetermined distance from a front surface and a rear surface of the reflecting panel 110 through spacing support 500 (refer to FIGS. 14 and 15 to be described later).

Although feeding lines for the radiating elements 120 and 130 may preferably be formed by printing patterns on a surface of a general printed circuit board (PCB), the PCB has a problem in that signal loss is significant due to a dielectric constant of an FR-4 material itself. In order to solve the problem of such loss, a transmission line structure in an air strip form may be advantageous. However, when it is intended to implement a phase shifter in the transmission line structure in the air strip form, the structure is required to be used in combination with a plurality of cables and PCBs, thereby causing a problem of deteriorated appearance and increased weight. In such a structure, an impedance matching element is additionally applied, and it becomes difficult to alleviate loss due to an increase in discontinuous sections.

Therefore, the antenna apparatus 1 according to an embodiment of the present disclosure employs a transmission line structure in an air strip form so as to prevent signal loss due to the dielectric constant of the material of the PCB, and also employs phase shifters 400A and 400B configured to shift phase values through variation of the dielectric constant, so as to prevent deteriorated appearance and increased weight.

In particular, the antenna apparatus 1 according to an embodiment of the present disclosure proposes a technical feature in which the transmission lines 200 and 300 are manufactured in a form of general conductor strips, and disposed to be spaced apart by a predetermined distance from the front surface and the rear surface of the reflecting panel 110 using spacing supports 500, and a dielectric panel 450 for phase adjustment, which is a core component of each of the phase shifters 400A and 400B, may be inserted and disposed in each spacing space therebetween.

Describing this in more detail, as referred to in FIGS. 8 to 12B, the phase shifters 400A and 400B of the antenna apparatus 1 according to an embodiment of the present disclosure may include a low-band phase shifter 400A, which operates on the front side of the reflecting panel 110 to shift phase values of radiation beams of the low-band elements 120 and a mid-band phase shifter 400B, which operates on the rear side of the reflecting panel 110 to shift phase values of radiation beams of the mid-band elements 130.

Hereinafter, in the following description, the first frequency band will be defined as a low band, which radiates a frequency defined to have an operating frequency between 600 MHz and 800 MHz and forms a low beam of a low frequency band (beamforming), and the second frequency band will be defined as a mid band, which radiates a frequency defined to have an operating frequency between 1.7 GHZ and 2.4 GHZ and forms a mid-beam pattern of a mid-frequency band (beamforming).

In addition, the low-band d transmission line 200 provided to feed the low-band elements 120 may be defined as a first transmission line, and the mid-band transmission line 300 provided to feed the mid-band elements 130 may be defined as a second transmission line.

First, the low-band phase shifter 400A of the phase shifters 400A and 400B of the antenna apparatus 1 according to an embodiment of the present disclosure will be specifically described as follows. The mid-band phase shifter 400B, as will be described later, differs from the low-band phase shifter 400A only in a position of a driving motor 410, and since the remaining configuration and theoretical principle thereof are the same, detailed description thereof will be omitted to the extent of duplication, and differences will be mainly described later.

As referred to in FIGS. 8 to 12B, the low-band phase shifter 400A may include a driving motor 410 that is electrically driven to generate rotational force, a plurality of vertical moving bars 430C, 430L, and 430R that receive the rotational force generated from the driving motor 410 and move in the vertical direction (V-direction) on the front surface of the reflecting panel 110, and a plurality of moving clamps 440 that are coupled to a plurality of positions of the plurality of vertical moving bars 430C, 430L, and 430R to move in the vertical direction in conjunction with the vertical moving bars 430C, 430L, and 430R.

Here, the driving motor 410 of the low-band phase shifter 400A may be provided in a form of a gear box at a lower side of the rear surface of the reflecting panel 110. A rotating shaft of the driving motor 410 may be disposed in the forward and backward direction, and pass through the reflecting panel 110 to be exposed to the front side of the reflecting panel 110. A pinion gear having pinion gear teeth 411 formed on an outer circumferential surface thereof may be rotatably connected to the rotating shaft of the driving motor 410.

In addition, the plurality of vertical moving bars 430C, 430L, and 430R may include three bars, including a center moving bar 430C formed to extend in the vertical direction at a front center of the reflecting panel 110, a left moving bar 430L disposed to be spaced apart from and parallel to the center moving bar 430C at a front left side of the reflecting panel 110, and a right moving bar 430R disposed to be spaced apart from and parallel to the center moving bar 430C at a front right side of the reflecting panel 110.

The three vertical moving bars 430C, 430L, and 430R may be coupled to each other via a connection bar 425 that connects lower ends thereof in the horizontal direction. A rack gear 420 having rack gear teeth 421 that engage with the pinion gear teeth 411 of the above-described pinion gear may be formed to extend in the vertical direction and coupled to the connection bar 425.

When the driving motor 410 is electrically driven to generate rotational force, the pinion gear is rotated, and the rack gear 420 is moved in the vertical direction (V-direction) by the rack gear teeth 421 that engage with the pinion gear teeth 411. Here, the three vertical moving bars 430C, 430L, and 430R coupled by the connection bar 425 move in an interlocked manner in the V-direction, thereby moving the plurality of moving clamps 440 in an interlocked manner. As referred to in FIGS. 8 to 12, the low-band phase

shifter 400A may further include a dielectric panel 450 for phase adjustment (hereinafter referred to simply as “phase dielectric”) movably disposed at the branch points S1, S2, and S3 of the first transmission line 200 disposed to be spaced apart from the front surface of the reflecting panel 110, and a dielectric panel 460 for impedance matching (hereinafter referred to simply as “impedance dielectric”) fixed disposed parallel to one side of the phase dielectric 450.

The phase dielectric 450 functions to shift phase values of the low-band elements 120 by changing a dielectric constant at the branch points S1, S2, and S3 on the first transmission line 200 while moving in the V-direction by the above-described moving clamps 440.

As referred to in FIGS. 11a and 11b, each of the moving clamps 440 may include a clamp body 441 secured to the corresponding vertical moving bar 430C, 430L or 430R (hereinafter, collectively referred to by the reference numeral “430”) via a bridge bar 443 extending perpendicularly from the vertical moving bar 430, a coupling dielectric 444 coupled to a rear surface of the clamp body 441 to mediate coupling of the phase dielectric 450 to the clamp body 441 with the transmission line 200 interposed therebetween, and an elastic element 445 provided in the clamp body 441 to elastically support the transmission line 200 toward the phase dielectric 450.

The plurality of vertical moving bars 430 may be guided to move upward and downward by a plurality of support roller portions 470 disposed at predetermined intervals in the V-direction. A specific configuration of the support roller units 470 will be described in more detail later.

The coupling dielectric 444 may be a component configured to move in conjunction with the clamp body 441 at a front side of the transmission line 200, may be formed of a dielectric material, and may be configured so as not to affect the dielectric constant other than a change in the dielectric constant of the phase dielectric 450 that moves between the transmission line 200 and the front surface of the reflecting panel 110.

The elastic element 445 may elastically bring the coupling dielectric 444 into close contact with the transmission line 200, and thereby allow the transmission line 200 and the phase dielectric 450 to move in contact with each other with a uniform close contact force.

Hereinafter, the mid-band phase shifter 400B of the phase shifters 400A and 400B of the antenna apparatus 1 according to an embodiment of the present disclosure will be described, focusing only on portions that differ in comparison with the above-described low-band phase shifter 400A. The remaining configurations not described may be regarded as being the same as those of the low-band phase shifter 400A.

As referred to in FIGS. 8 to 12B, the mid-band phase shifter 400B may shift phase values through changes in dielectric constant generated while moving the phase dielectrics 450 respectively disposed at the branch points S1, S2, and S3 of the second transmission line 300 disposed to be spaced apart from the rear surface of the reflecting panel 110.

Here, with regard to the plurality of vertical moving bars 430, unlike in the case of the low-band phase shifter 400A in which the center moving bar 430C is provided, the mid-band phase shifter 400B may be provided with only the left moving bar 430L and the right moving bar 430R.

Furthermore, in the case of the low-band phase shifter 400A, the bridge bar 443 extends in the left and right direction only from the center moving bar 430C, and two clamp bodies 441 are provided on each bridge bar 443, whereas in the left moving bar 430L and the right moving bar 430R, one clamp body 441 is provided on each bridge bar 443. In the case of the mid-band phase shifter 400B, the bridge bar 443 extend in the left and right direction from each of the moving bars 430L and 430R, and two clamp bodies 441 are provided on each bridge bar 443, which constitutes a difference.

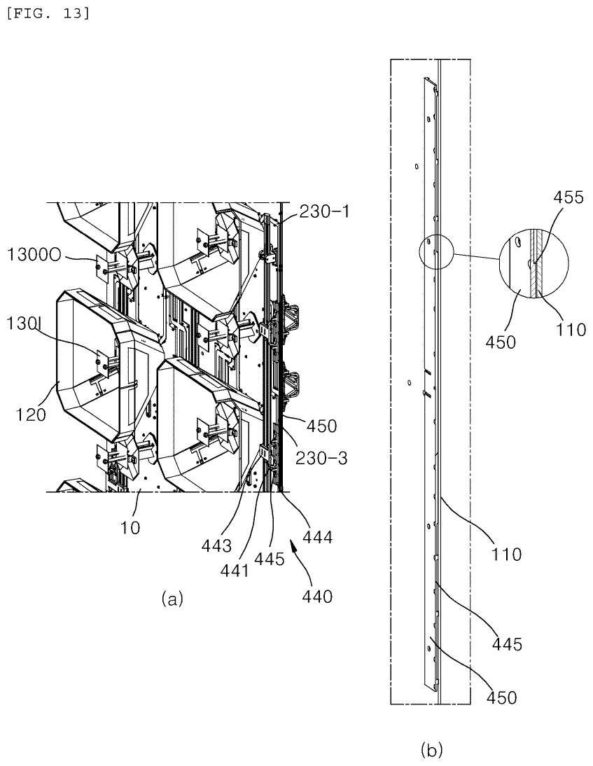

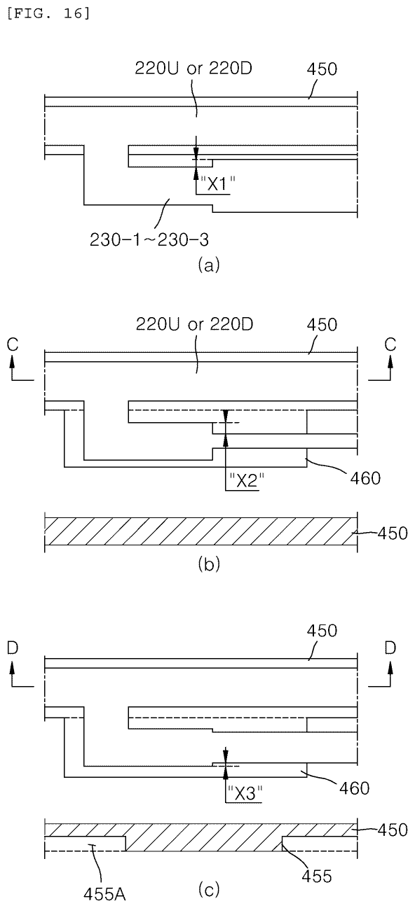

FIG. 13 is a cutaway perspective view illustrating a dielectric panel for phase adjustment among components of the phase shifter for antenna apparatuses according to an embodiment of the present disclosure, and an enlarged view of a portion thereof. FIG. 14 is a partially enlarged perspective view for explaining an operation of the phase shifter for antenna apparatuses according to an embodiment of the present disclosure. FIG. 15 is a sectional view taken along line B-B of FIG. 14. FIG. 16 is a schematic view for explaining a function of the dielectric panel for phase adjustment among the components of the phase shifter for antenna apparatuses according to an embodiment of the present disclosure.

The phase shifters 400A and 400B shift phase values through changes in dielectric constant of the phase dielectrics moving in the V-direction, whereby the plurality of vertical moving bars 430, which are provided to directly move the phase dielectrics, are required to reliably move in a vertical linear motion without being displaced.

To this end, as referred to in FIG. 14, the plurality of support roller units 470 may be provided to support upper and lower surfaces of the vertical moving bar 430 in a rolling manner.

Each of the plurality of support roller units 470 may include a pair of roller coupling brackets 471 that are respectively provided to protrude forward or rearward at left and right sides of the vertical moving bar 430, and a first roller 472 and a second roller 473 that are rotatably provided on the pair of roller coupling brackets 471. The first roller 472 may rotatably support one surface of the vertical moving bar 430, and the second roller 473 may rotatably support another surface of the vertical moving bar 430.

Due to the plurality of support roller units 470 as described above, the vertical moving bar 430 may reliably move upward and downward with minimized movement resistance, spaced apart by a predetermined distance from the front and rear surfaces of the reflecting panel 110.

As referred to in FIG. 15, the first transmission line 200 and the second transmission line 300 may be provided in an air strip line form to be spaced apart by a predetermined distance D1 from the front surface or the rear surface of the reflecting panel 110 by a plurality of spacing supports 500.

Each of the spacing supports 500 may include a panel hook portion 510 inserted into and fastened to a hook hole (reference numeral not shown) formed in the reflecting panel 110, and a line seating portion 520 provided opposite to the panel hook portion 510 and configured to allow the first transmission line 200 or the second transmission line 300 to be seated thereon.

The panel hook portion 510 may be formed with panel hook ends 515 each penetrating through and hooking to the hook hole. The line seating portion 520 may also be formed with line hook ends 525 on which opposite side edges of the first transmission line 200 or the second transmission line 300 seated thereon are hooked.

The phase shifters 400A and 400B of the antenna apparatus 1 according to an embodiment of the present disclosure may operate on a principle of shifting phase values at the branch points S1, S2, and S3 of the first transmission line 200 and the second transmission line 300 by a change in dielectric constant according to movement of the phase dielectric 450.

However, in order to more accurately implement shifting of phase values through a change in dielectric constant, impedance dielectrics 460 are required to be fixedly disposed on the input lines 310L and 310R corresponding to one side of the phase dielectric 450 or on some of the branch points S1, S2, and S3 of the transmission lines 320U and 320D before branching.

Here, it is preferable that each of the phase dielectrics 450 be disposed between one surface of the reflecting panel 110 and the transmission line 200 or 300 in an air strip line form spaced apart from the one surface of the reflecting panel 110, but it is not necessary to be installed on all of the transmission lines 200 and 300. The transmission lines 200 and 300 may be formed along the branch points S1, S2, and S3 where the plurality of branch lines 220U, 220D, 320U, and 320D branch out from the input lines 210L, 210R, 310L, and 310R to feed the plurality of radiating elements 120 and 130.

As referred to in (c) of FIG. 16, the phase dielectric 450 may be formed with an impedance matching step 455 stepped such that an air layer 455A is formed on a surface facing the reflecting panel 110.

In addition, the impedance dielectric 460 may be longitudinally disposed between the input lines 210L and 210R or 310L and 310R corresponding to the branch point S1 among the branch points S1, S2, and S3 and one surface of the reflecting panel 110, or between the upper transmission lines 220U and 320U and the lower transmission lines 220D and 320D corresponding to the branch points S2 and S3 among the branch points S1, S2, and S3 and one surface of the reflecting panel 110. Here, the impedance matching step 455 is preferably formed within a longitudinal range of the impedance dielectric 460.

The impedance matching step 455 formed in the phase dielectric 450 as described above may form a dielectric layer of a predetermined thickness such as the air layer 455A between one surface of the reflecting panel 110 and the phase dielectric 450, thereby minimizing a change in the width of the first transmission line 200 or the second transmission line 300 that needs to inevitably be changed for impedance matching.

For example, as referred to in (a) of FIG. 16, in the case where only the phase dielectric 450 is provided without the impedance dielectric 460, a variation in the width of the input lines 210L and 210R of the first transmission line 200, the input lines 210L and 210R corresponding to lines before branching of the branch points S1, S2, and S3, or of the upper transmission line 220U and the lower transmission line 220D, in order to implement an effective phase shift, is significantly large as “X1,” and thus there is a risk of interference with a branch line on one side.

Furthermore, as referred to in (b) of FIG. 16, even in the case where the impedance dielectric 460 is provided together with the phase dielectric 450 but no impedance matching step 455 is formed in the phase dielectric 450, there is a problem in that a variation range in the width of the first transmission line 200 or the second transmission line 300 becomes “X2,” which is larger than in the case of X1.

In this case, as referred to in (c) of FIG. 16, when the impedance matching step 455 is formed in the phase dielectric 450, the variation range in the width of the first transmission line 200 or the second transmission line 300 can be minimized to “X3”, thereby not only allowing for the simplicity of the overall external shape of the transmission lines 200 and 300, but also providing the advantage of enabling an effective phase shift.

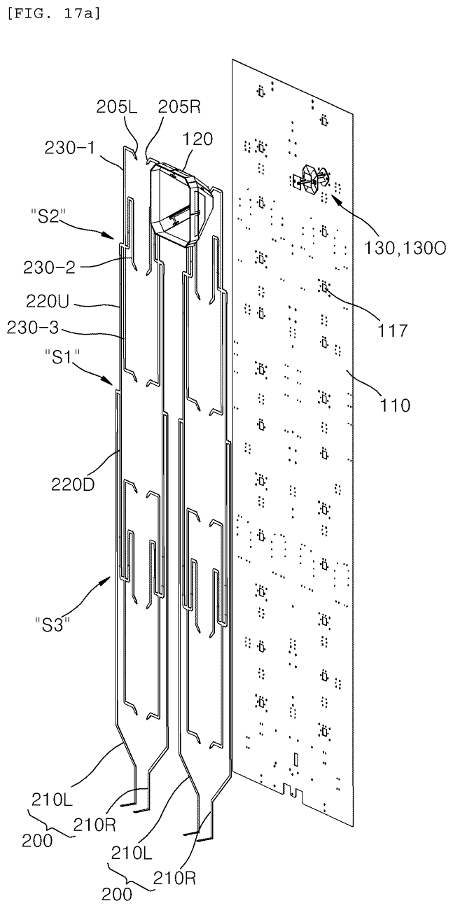

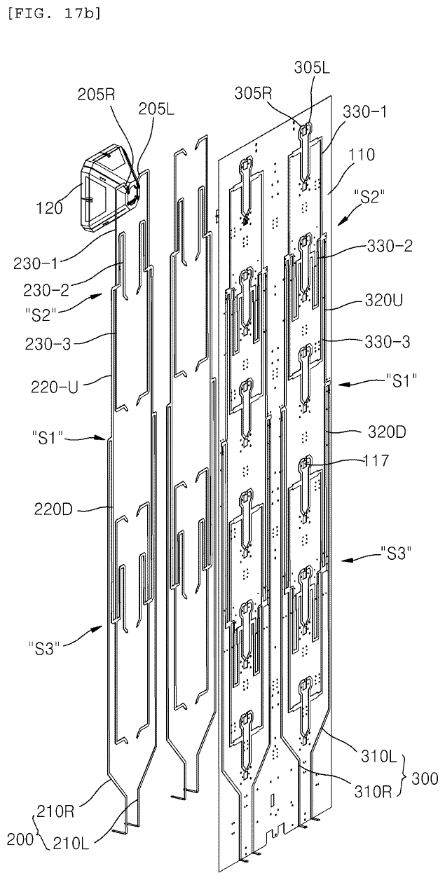

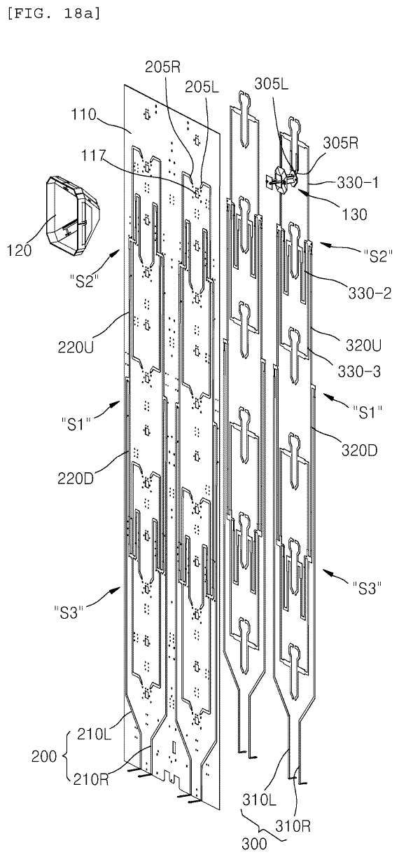

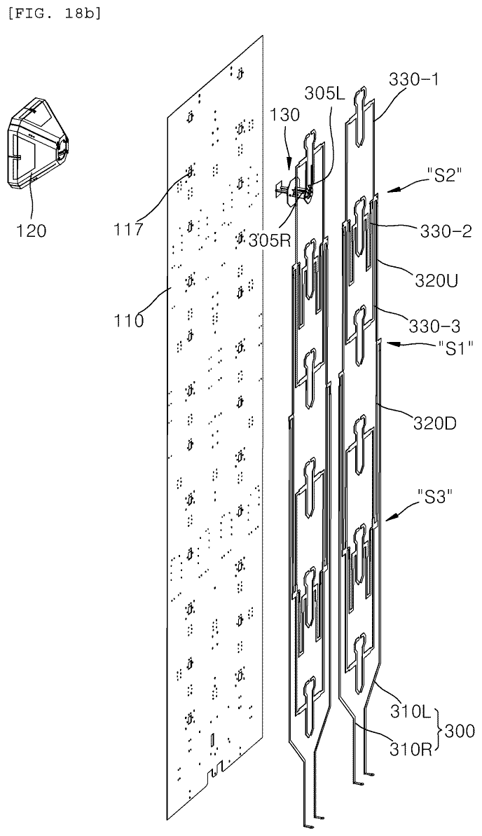

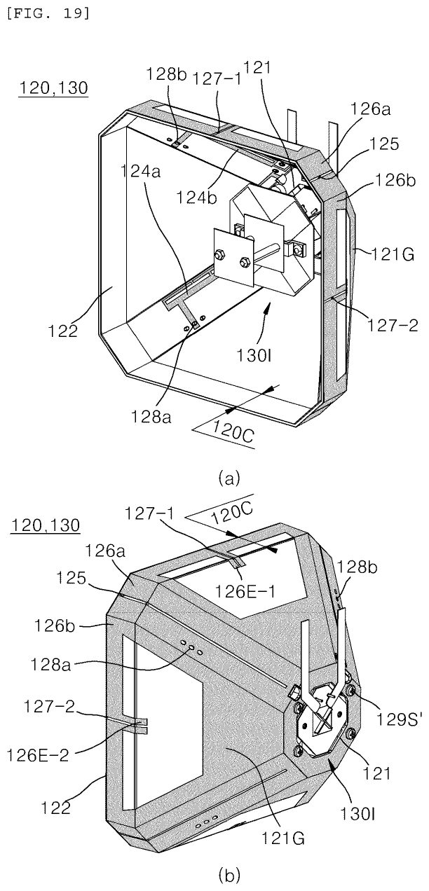

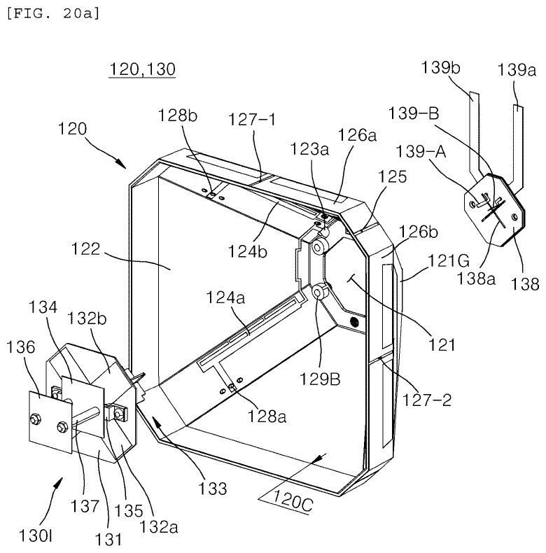

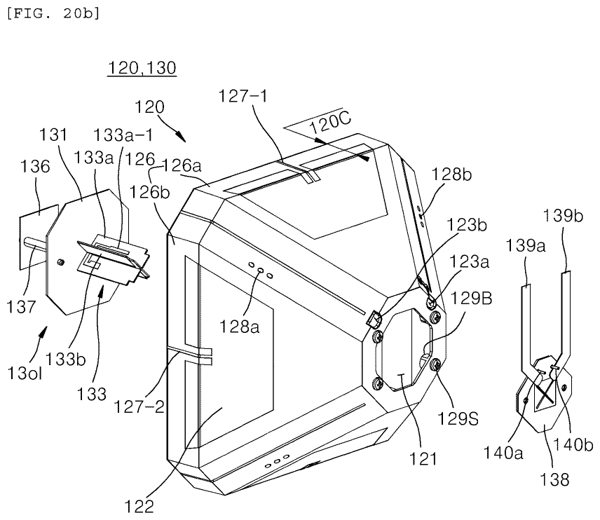

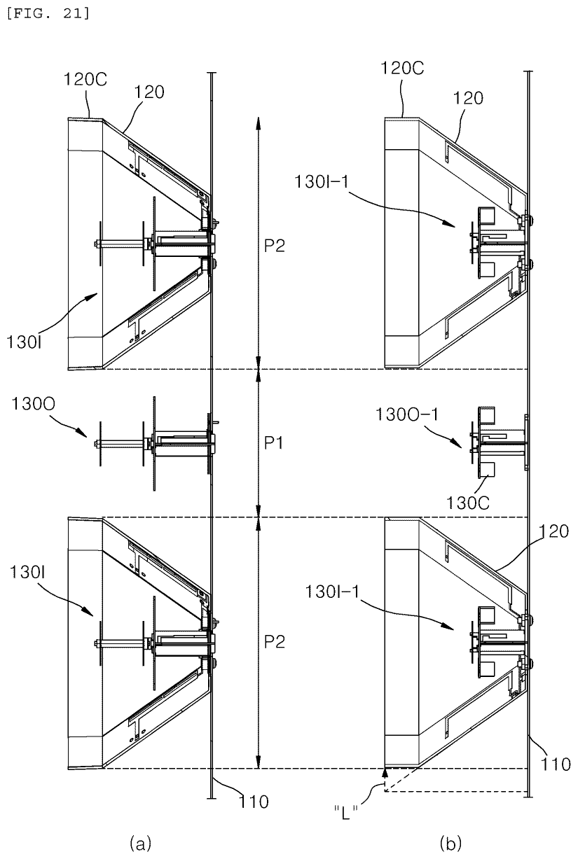

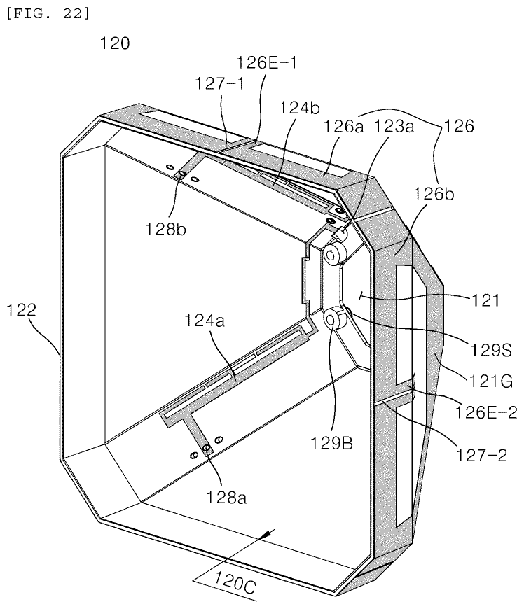

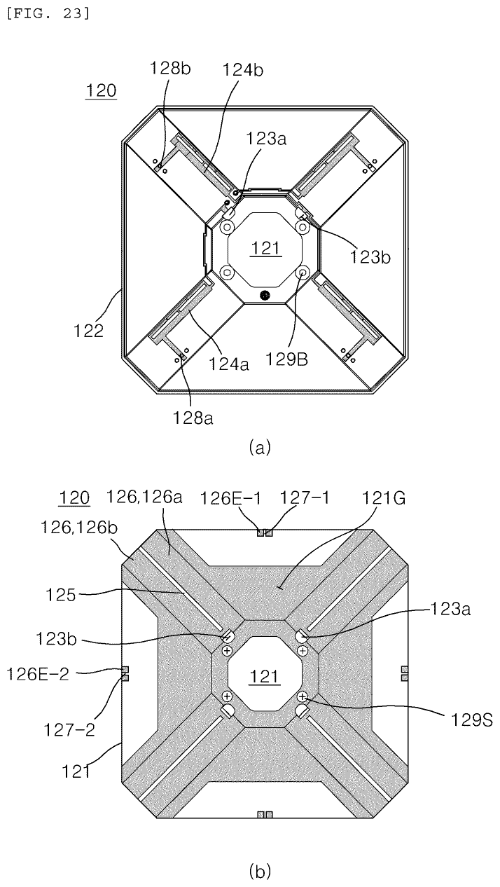

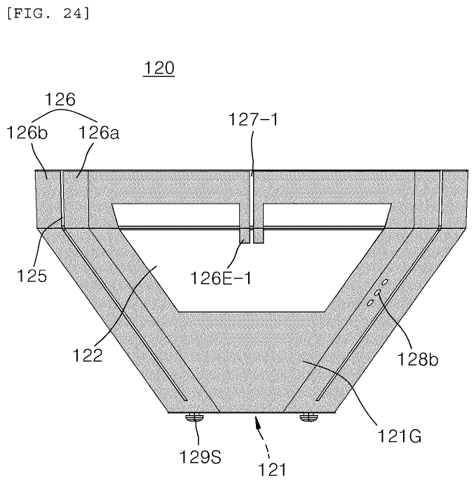

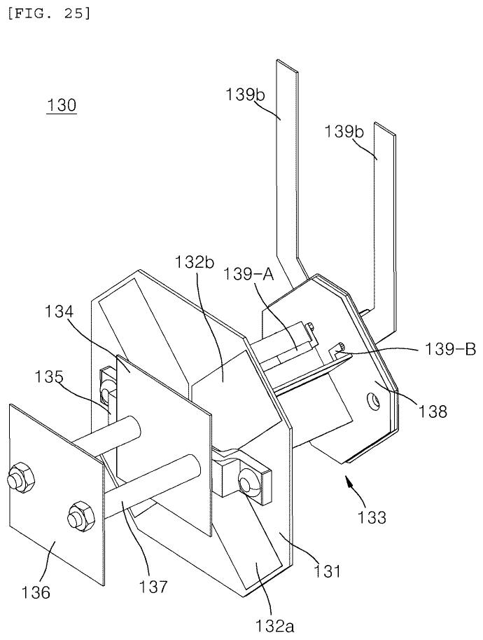

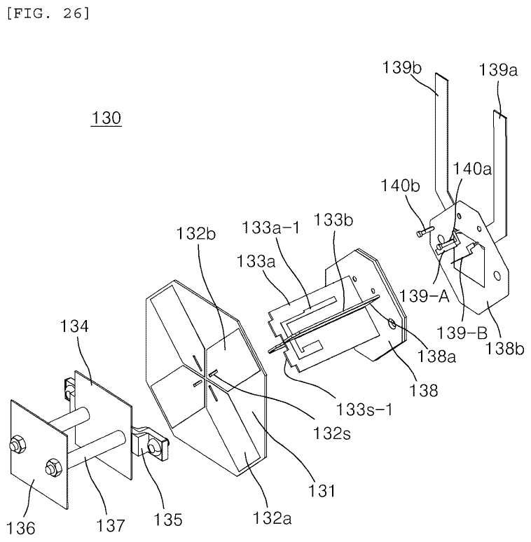

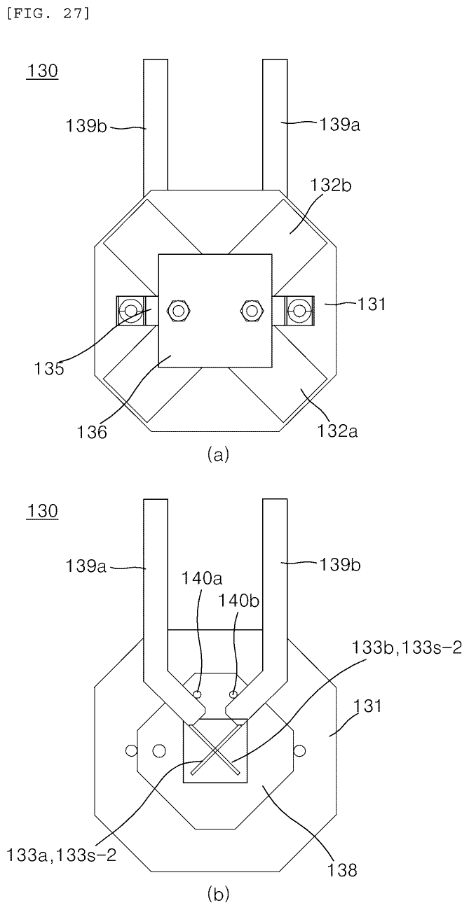

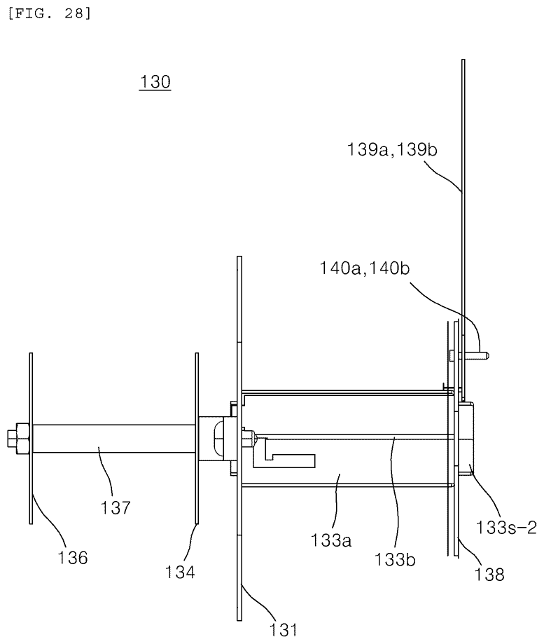

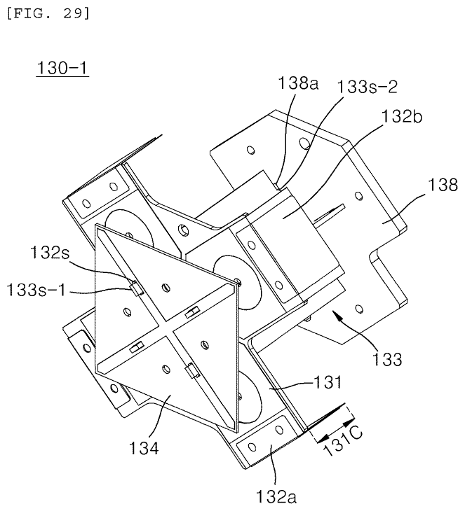

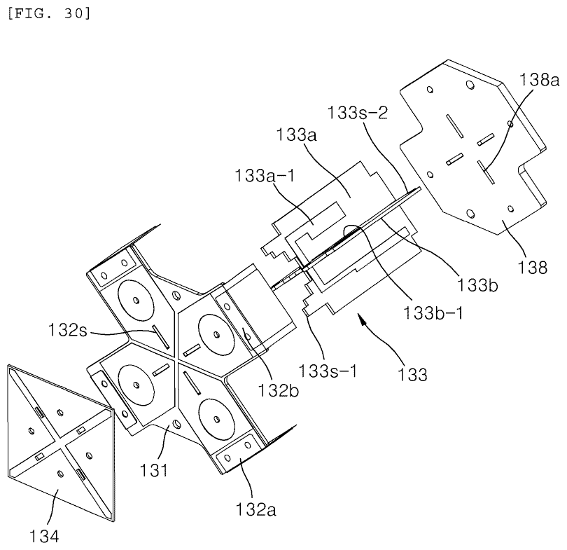

FIGS. 17a and 17b are exploded perspective views illustrating coupling of the low-band element to the reflecting panel and the transmission line. FIGS. 18a and 18b are exploded perspective views illustrating coupling of the mid-band element to the reflecting panel and the transmission line. FIG. 19 shows front and rear perspective views illustrating coupling of radiating elements among the components of the antenna apparatus according to an embodiment of the present disclosure. FIGS. 20a and 20b are respectively front and rear exploded perspective views of FIG. 19. FIG. 21 is a sectional view illustrating arrangement of the radiating elements with respect to the reflecting panel according to various examples among the components of the antenna apparatus according to an embodiment of the present disclosure. FIG. 22 is a perspective view illustrating the low-band element among the components of the antenna apparatus according to an embodiment of the present disclosure. FIG. 23 illustrates a front view and a rear view of FIG. 22. FIG. 24 is a side view of FIG. 22. FIG. 25 is a perspective view illustrating the mid-band element among the components of the antenna apparatus according to an embodiment of the present disclosure. FIG. 26 is an exploded perspective view of FIG. 25. FIG. 27 illustrates a front view and a rear view of FIG. 25. FIG. 28 is a side view of FIG. 25. FIG. 29 illustrates another example of the mid-band element among the components of the antenna apparatus according to an embodiment of the present disclosure. FIG. 30 is an exploded perspective view of FIG. 29.

As referred to in FIGS. 17a to 21, the low-band elements 120 and the mid-band elements 130 may be secured to the front surface of the reflecting panel 110.

Here, the inner mid-band elements 130I, which interfere in a radiation direction with the low-band elements 120, among the plurality of mid-band elements 130, may be disposed to penetrate the centers of the respective low-band elements 120. For penetration installation of the inner mid-band elements 130I among the mid-band elements 130 with respect to the low-band elements 120, the element installation holes 121 as described above may be formed to pass through the centers of the low-band elements 120 in the forward and backward direction.

The plurality of low-band elements 120 and the plurality of mid-band elements 130 may be secured to the front surface of the reflecting panel 110, and may be independently fed by the first transmission line 200 disposed on the front surface of the reflecting panel 110 and the second transmission line 300 disposed on the rear surface of the reflecting panel 110.

To this end, front-rear through holes 117 may be formed to pass through the reflecting panel 110 in the forward and backward direction so as to be connected at least to the second transmission line 300. A base panel 138 of each mid-band element 130 to be described later may be secured in place through the corresponding front-rear through hole 117.

Here, as referred to in FIGS. 22 to 24, each of the plurality of low-band elements 120 may include a low-band element body 122 that is formed of a non-conductive material and has at the center thereof the above-described element installation hole 121 through which the corresponding mid-band element 130 (particularly, the inner mid-band element 130I) is installed.

As referred to in FIGS. 22 to 24, the low-band element body 122 may be formed in a square pyramid shape that has a vertical cross-section with a substantially square shape at a front end thereof and gradually decreases in vertical cross-sectional area toward the element installation hole 121 positioned at a rear end thereof.

However, for stable coupling to the front surface of the reflecting panel 110 and for formation of the above-described element installation hole 121, the low-band element body 122 does not necessarily need to have a complete apex like a square pyramid. Instead, the rear end of the low-band element body 122 may be formed in a surface shape so as to form a dipole pattern 126 to be described later at respective rear corners (four corners) thereof, and the rear end of the low-band element body 122 and the element installation hole 121 may be formed in a regular hexagonal (or hexagonal) shape.

Here, the plurality of low-band element bodies 122 may be formed of a lightweight non-conductive plastic material, thereby significantly reducing an overall weight of the antenna board assembly 100 as compared with the existing art.

The rear end of the low-band element body 122 in which the element installation hole 121 is formed may be formed flat such that a perimeter thereof is in surface contact with the front surface of the reflecting panel 110. Edges extending from the portion in which the element installation hole 121 is formed to the respective corners of the square vertical cross-section of the low-band element body 122 may be cut in a flat chamfered shape so as to provide surfaces rather than edges, such that respective portions of the dipole pattern 126 to be described later may be pattern-printed thereon. Hereinafter, the edges of the low-band element body 122 where the dipole pattern 126 is formed will be referred to as “edge surfaces.”

In addition, the element installation hole 121 may be formed to have a size such that the inner mid-band element 130I, which is disposed to overlap the low-band element 120 in the region P2 with beam interference among the mid-band elements 130, can be installed to pass therethrough.

Here, the element installation hole 121 is preferably formed to have a size through which the base panel 138 and a balun portion 133, excluding a radiating panel 131 among components of the mid-band element 130, can pass in the forward and backward direction.

The dipole pattern 126 made of a conductive material and configured to radiate at least one polarized beam of dual polarization may be plated on outer surfaces of the edge surfaces of the low-band element 120.

The dipole pattern 126 serves to form dipole antenna patterns centered on respective edge surfaces of the low-band element 120, and to radiate polarized beams of +45 degrees and −45 degrees by being combined with other dipole antenna patterns connected in an “X” shape.

As referred to in FIGS. 22 to 24, the dipole pattern 126 may be plated to close a peripheral edge portion of the element installation hole 121, and may be further plated such that a front end thereof extends from the peripheral edge portion of the element installation hole 121 forward along edges of the low-band element body 122 having a square front perimeter that serves as the front end of the low-band element body 122.

The dipole pattern 126 may include a ground portion 121G, which is plated on the peripheral edge portion of the element installation hole 121 to ground the mid-band element 130. The ground portion 121G may be plated to completely close the peripheral edge portion of the element installation hole 121 through which the mid-band element 130 is installed, thereby enabling a design without an additional structure by eliminating a configuration such as a separate ground panel performing a grounding function in the existing art, and preventing an increase in weight in advance.

As referred to in FIGS. 22 to 24, the dipole pattern 126 may include a pair of dipole radiation ends 126a and 126b, which are plated in a T-shape branching along adjacent sides of a square vertical cross-section at the front end of the low-band element body 122.

The pair of dipole radiation ends 126a and 126b preferably have bent distal ends 126E-1 and 126E-2. A distance between the bent ends 126E-1 and 126E-2 is preferably formed to have a size of λ/2, which is a half value (½) of a wavelength (operating frequency=λ) of the corresponding frequency band.

In the antenna apparatus 1 according to an embodiment of the present disclosure, considering a wavelength (λ) of a resonance frequency in a low frequency band, the size of the low-band element 120 may be increased. To prevent this, as referred to in FIG. 22, the respective distal ends 126E-1 and 126E-2 of the pair of dipole radiation ends 126a and 126b located at a bent surface 120C to be described later may be bent and extended, thereby achieving λ/2, which is a length of a dipole antenna, and minimizing the size of the low-band element 120.

In addition, as the respective distal ends 126E-1 and 126E-2 of the pair of dipole radiation ends 126a and 126b are bent, a C value (capacitance) of the circuit increases. Considering that a resonance frequency is inversely proportional to the C value (capacitance) of the circuit, the frequency band can be further lowered due to the increase in the C value (capacitance).

Accordingly, the low-band element 120 has an advantage of being able to smoothly radiate signals in a low frequency band.

Here, the front end of the low-band element body 122 on which the dipole radiation ends 126a and 126b are plated may have the bent surface 120C bent with respect to an inclined side surface (reference numeral not shown) that extends obliquely with respect to the front surface of the reflecting panel 110 on which the low-band elements 120 and the mid-band elements 130 are installed.

As referred to in FIG. 21, the bent surface 120C is provided to reduce a vertical cross-sectional area of the low-band element body 122 as compared with an area of the square vertical cross-section in the case where the low-band element body 122 does not have the bent surface 120C, thereby additionally securing a beam projection region (see reference symbol “L” in FIG. 21) forward of the outer mid-band elements 1300 disposed in the regions P1 without beam interference. That is, the bent surface 120C may be bent to a degree of reducing the vertical cross-sectional area of the square front end of the low-band element 120 so as to avoid beam interference of the mid-band element 130 disposed between adjacent low-band elements 120.

In particular, the bent surface 120C may be formed to be bent perpendicular to the front surface of the reflecting panel 110.

The distal ends 126E-1 and 126E-2 of the dipole radiation ends 126a and 126b may be spaced apart from the distal ends 126E-1 and 126E-2 of adjacent dipole radiation ends 126a and 126b with predetermined spacing lines 127-1 and 127-2 interposed therebetween, and may be plated to be bent and extended toward the element installation hole 121 by a predetermined ratio with respect to the area of the vertical cross-section reduced by the bent surface 120C so as to be arranged parallel to each other.

As referred to in FIGS. 22 to 24, inner feeding patterns 124a and 124b made of a conductive material for feeding the dipole pattern 126 may be plated on an inner surface of the low-band element body 122 of the low-band element 120.

Respective one ends of the inner feeding patterns 124a and 124b may be connected to an output end of the first transmission line 200, and respective remaining ends of the inner feeding patterns 124a and 124b may be electrically connected to the dipole pattern 126 through feeding via holes 128a and 128b formed through inner and outer sides of the low-band element body 122.

The inner feeding patterns 124a and 124b may be electrically connected to the first transmission line 200 through transmission line connection holes 123a and 123b formed around the element installation hole 121 of the low-band element body 122.

The dipole pattern 126 and the inner feeding patterns 124a and 124b may be pattern-plated on the low-band element body 122 through a plastic electro-plating (PEP) process. The PEP process, although not illustrated in the drawings, is a process in which an entire injection-molded product made of a thermoplastic resin is metallized and then subjected to application of current (electroplating), such that only a desired pattern remains and other portions are removed by being peeled off through a chemical reaction. Here, the PEP process has an advantage of being favorable for pattern formation on relatively complex objects as compared with a general plating method.

The low-band element 120 having the aforementioned configuration may be secured to the front surface of the reflecting panel 110 by fastening screws 129S, which penetrate from the rear surface of the reflecting panel 110 and are fastened into screw coupling bosses 129B formed on the peripheral edge portions of the element installation hole 121.

As referred to in FIGS. 25 to 28, each of the plurality of mid-band elements 130 may include a base panel 138 that mediates coupling to the reflecting panel 110, a balun portion 133 having a rear end secured to the base panel 138 and on which outer feeding patterns 133a-1 and 133a-2 are printed, a radiating panel 131 secured to a front end of the balun portion 133 and having dipole patterns 132a and 132b which are connected to the outer feeding patterns 133a-1 and 133a-2 to radiate a predetermined pattern beam, and a radiating director 134 stacked and disposed on a front side of the radiating panel 131.

The dipole patterns 132a and 132b formed on the radiating panel 131 are made of a conductive material, and are provided in an “X” shape on the radiating panel 131 to serve to form polarized beams of +45 degrees and −45 degrees.

The outer feeding patterns 133a-1 and 133a-2 may be formed such that portions of ends thereof connected to the dipole patterns 132a and 132b are bent toward the reflecting panel 110.

Here, the outer feeding patterns 133a-1 and 133a-2 are not necessarily required to be bent, and may not be bent to the extent that a pattern beam of the inner mid-band element 130I, which is installed through the element installation hole 121 of the low-band element 120, is not affected by the low-band element 120.

For example, as referred to in FIGS. 25 to 28, in the case where the mid-band element 130 further includes an extended director panel 136 disposed to be spaced apart from the radiating director 134 forward so as to minimize influence of pattern beam interference of the low-band element 120, the outer feeding patterns 133a-1 and 133a-2 may not be required to be bent.

Here, the radiating director 134 may be provided to protrude forward of the radiating panel 131 via a mounting bracket 135.

The radiating director 134 functions to reduce influence of a pattern beam of the low-band element 120 and guide a radiation direction of a pattern beam of the mid-band element 130 in a forward direction.

In addition, the extended director panel 136 may be coupled to the radiating director 134 via an extended connector 137 extending from a front end of the radiating director 134.

However, as referred to in FIGS. 29 and 30, in the case of an embodiment in which the extended director panel 136 is not provided, it is preferable that the outer feeding patterns 133a-1 and 133a-2 be bent to minimize pattern beam radiation interference.

The outer feeding patterns 133a-1 and 133a-2 of the balun portion 133 may be electrically connected to the second transmission line 300 by lead terminals 139a and 139b.

Front ends 139-A and 139-B of the lead terminals 139a and 139b may pass through the base panel 138 and be connected to the outer feeding patterns 133a-1 and 133a-2, respectively, and electric conduction may be made via a pair of solder pins 140a and 140b.

As such, the antenna apparatus 1 according to an embodiment of the present disclosure provides an advantage of improving beam forming performance by disposing the low-band elements 120 and the mid-band elements 130 related to dual frequency bands in an overlapping manner, and by reducing the size of each low-band element 120 to an appropriate size to minimize interference caused by each pattern beam.

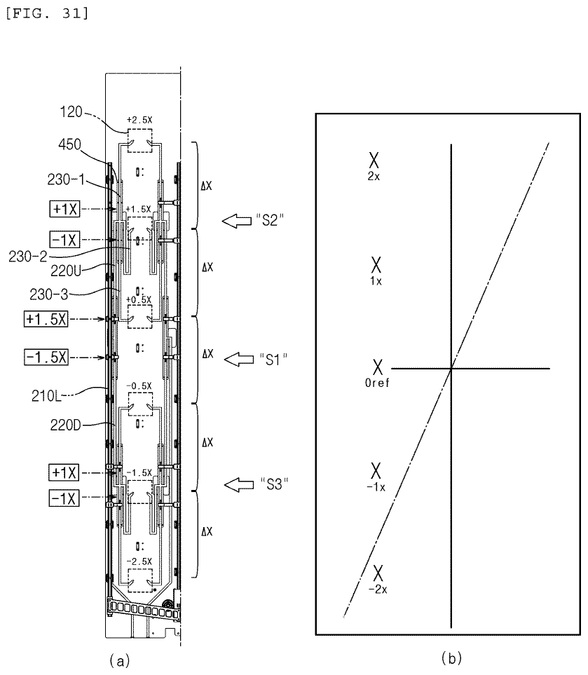

FIG. 31 illustrates a partial front view (a) of a first transmission line for explaining phase difference implementation according to position and depth adjustment of an impedance matching step of the phase dielectric among the components of the phase shifter of the antenna apparatus according to an embodiment of the present disclosure, and a graph (b) illustrating an ideal phase difference.

In the antenna apparatus 1 according to an embodiment of the present disclosure, six low-band elements 120 may be arranged in the vertical direction (V-direction) so as to be spaced apart from each other to form a single RF chain, as described above. Here, each low-band element 120 may be disposed such that a spacing distance between adjacent low-band elements 120 is the same as ΔX. The reason is that, generally, in the operation of the phase shifter 400A, a side lobe formed during beamforming can be minimized when a phase difference (ΔX) between the low-band elements 120 is the same, and thus a decrease in gain can also be minimized.

That is, it is preferable that the low-band phase shifter 400A of the phase shifters 400A and 400B of the antenna apparatus 1 according to an embodiment of the present disclosure be driven such that a phase value shifted by the low-band phase shifter 400A has the same phase difference with respect to a reference phase, as referred to in (b) of FIG. 31.

However, the phase dielectrics 450, as described above, are provided to move in conjunction with the moving clamps 440 by the plurality of vertical moving bars 430, and are disposed respectively at the first to third branch points S1, S2, and S3. In order to implement the above-described same phase difference (ΔX), there is a problem in that moving distances of the phase dielectrics 450 disposed at the respective branch points S1, S2, and S3 are required to be different from each other.

As such, moving each of the phase dielectrics 450 disposed at the branch points S1, S2, and S3 by different moving distances leads to a problem in that, due to spatial constraints of the first transmission line 200 provided in an air strip line form, a separate driving mechanism for independently driving each phase dielectric 450 is required.

As referred to in FIG. 30, in the phase shifters 400A and 400B of the antenna apparatus 1 according to an embodiment of the present disclosure, when a target phase value of each low-band element 120 is set to a maximum value of +2.5X and a minimum value of −2.5X, the low-band elements 120 are required to have the same phase difference (ΔX). To this end, the phase dielectric 450 disposed at the first branch point S1 may be machined to form an impedance matching step 455 such that phase differences of +1.5X and −1.5X are provided with respect to the upper transmission line 220U and the lower transmission line 220D, respectively. The phase dielectrics 450 disposed at the second branch point S2 and the third branch point S3 may be machined to form impedance matching steps 455 such that, except for the middle branch transmission line 230-2 among the three branch transmission lines 230-1 to 230-3, a phase difference of +1X is provided with respect to the upper branch transmission line 230-1 and a phase difference of −1X is provided with respect to the lower branch transmission line 230-3.

As described above, the phase shifters 400A and 400B of the antenna apparatus 1 according to an embodiment of the present disclosure provide an advantage in that the impedance matching steps 455 formed to be different in the phase dielectric 450 vary an effective dielectric constant, so that, even when the phase dielectrics 450 are physically moved by the same distance, the phase dielectrics 450 may be varied to different electrical phases.

The antenna apparatus 1 according to an embodiment of the present disclosure has been described in detail with reference to the accompanying drawings. However, the embodiment of the present disclosure is not necessarily limited to the above-described embodiment, and it will be apparent that various modifications and equivalent implementations can be made by those skilled in the art. Therefore, the true scope of rights of the present disclosure shall be defined by the claims to be described below.

### INDUSTRIAL APPLICABILITY

Embodiments of the present disclosure provide an antenna apparatus capable of optimally disposing a plurality of radiating elements of a multi-band antenna apparatus so as to achieve favorable antenna gain, minimizing weight of components to reduce overall product, and minimizing a thickness in a forward and backward direction occupied by predetermined components to manufacture the entire product in a slim form.

1. An antenna apparatus comprising:
a plurality of low-band elements configured to radiate an operating frequency in a first frequency band; and
a plurality of mid-band elements configured to radiate an operating frequency higher than the operating frequency in the first frequency band,
wherein a dipole pattern configured to radiate at least one polarized beam of dual polarization is plated on an outer surface of each of the plurality of low-band elements.

2. The antenna apparatus of claim 1, wherein the plurality of low-band elements and the plurality of mid-band elements are each secured to a front surface of a reflecting panel and are independently fed by a first transmission line disposed on the front surface of the reflecting panel and a second transmission line disposed on a rear surface of the reflecting panel.

3. The antenna apparatus of claim 2, wherein the first transmission line and the second transmission line are respectively provided in an air strip line form spaced apart from the front surface and the rear surface of the reflecting panel by a predetermined distance by a plurality of spacing supports.

4. The antenna apparatus of claim 1, wherein among the plurality of mid-band elements, mid-band elements that interfere in a radiation direction in relation to the low-band elements are disposed to penetrate centers of the low-band elements.

5. The antenna apparatus of claim 4,
wherein each of the plurality of low-band elements comprises a low-band element body formed of a non-conductive material and having, at a center thereof, an element installation hole formed to pass therethrough in a forward and rearward direction so that the corresponding mid-band element is installed to penetrate through the element installation hole, and
wherein the dipole pattern is plated to close a peripheral edge portion of the element installation hole, and is plated such that a front end thereof extends from the peripheral edge portion of the element installation hole forward along edge surfaces formed by cutting, in a flat chamfered form, edges of the low-band element body having a square front perimeter that serves as the front end of the low-band element body.

6. The antenna apparatus of claim 5, wherein the dipole pattern comprises a ground portion plated on the peripheral edge portion of the element installation hole and configured to ground the mid-band element.

7. The antenna apparatus of claim 5, wherein the dipole pattern comprises a dipole radiation end plated in a T-shape branching along adjacent sides of a square vertical cross-section at the front end of the low-band element body.

8. The antenna apparatus of claim 7, wherein the front end of the low-band element body on which the dipole radiation end is plated comprises a bent surface bent with respect to an inclined side surface extending obliquely with respect to the front surface of the reflecting panel on which the low-band elements and the mid-band elements are installed.

9. The antenna apparatus of claim 8, wherein the bent surface is bent perpendicular to the front surface of the reflecting panel.

10. The antenna apparatus of claim 7, wherein the bent surface is bent to reduce the vertical cross-sectional area as compared with an area of the square vertical cross-section of the front end of the low-band element without the bent surface, so that beam interference of the mid-band element disposed between the adjacent low-band elements is avoided.

11. The antenna apparatus of claim 10, wherein a distal end of the dipole radiation end is spaced apart from a distal end of an adjacent dipole radiation end, and is plated to be bent and extended toward the element installation hole by a predetermined ratio with respect to an area of the vertical cross-section reduced by the bent surface, and to be arranged parallel to the distal end of the adjacent dipole radiation end.

12. The antenna apparatus of claim 2,
wherein an inner feeding pattern configured to feed the dipole pattern is plated on an inner surface of the low-band element,
wherein one end of the inner feeding pattern is connected to an output end of the first transmission line, and
wherein a remaining end of the inner feeding pattern is electrically connected to the dipole pattern through a feeding via hole passing through inner and outer sides of the low-band element.

13. The antenna apparatus of claim 12, wherein the dipole pattern and the inner feeding pattern are pattern-plated on the low-band element body through a plastic electro-plating (PEP) process.

14. The antenna apparatus of claim 5, wherein each of the plurality of mid-band elements comprises:
a base panel mediating coupling to the reflecting panel;
a balun portion having a rear end secured to the base panel and having an outer feeding pattern printed thereon;
a radiating panel secured to a front end of the balun portion, and formed with a dipole pattern connected to the outer feeding pattern and configured to radiate a predetermined pattern beam; and
a radiating director stacked and disposed on a front side of the radiating panel.

15. The antenna apparatus of claim 14, wherein the radiating panel is formed such that a portion of an end thereof forming the dipole pattern is bent toward the reflecting panel.

16. The antenna apparatus of claim 14, further comprising an extended director panel disposed to be spaced apart from the radiating director forward.

17. The antenna apparatus of claim 1, further comprising
an antenna housing comprising: a rear panel functioning as a structural frame; side panels coupled to left and right ends of the rear panel, and forming a thickness in a forward and backward direction; a radome panel coupled to front ends of the side panels and provided to form an internal space in which an antenna board assembly provided with the plurality of low-band elements, the plurality of mid-band elements, and the reflecting panel is installed; an upper cap panel configured to cover an open portion at an upper side; and a lower cap panel configured to cover an open portion at a lower side,
wherein a reinforcing frame configured to reinforce rigidity is coupled to an inner side of the rear panel.

18. The antenna apparatus of claim 17, wherein the antenna housing is made of either an aluminum material or a plastic resin material.

19. The antenna apparatus of claim 17, wherein the reinforcing frame comprises:
a plurality of left-right reinforcing bars coupled horizontally in a left and right direction to a front surface of the rear panel; and
a center reinforcing bar coupled vertically in an up and down direction to the plurality of left-right reinforcing bars and connecting intermediate portions of the plurality of left-right reinforcing bars.

20. The antenna apparatus of claim 17,
wherein the radome panel is coupled to the front ends of the side panels by a plurality of coupling clips, and
wherein a left sealer and a right sealer are respectively interposed between a left end of the radome panel and the corresponding side panel and between a right end of the radome panel and the corresponding side panel.
